(19) United States
(12) Patent Application Publication
(10) Pub. No.: US 2025/0217400 A1
(43) Pub. Date: Jul. 3, 2025

(54) LARGE LANGUAGE MODEL BASED NESTED SUMMARIZATION OF CONVERSATION DATA

(71) Applicant: LIVEPERSON, INC., New York, NY (US)

(72) Inventors: Courtney Mansfield, New York, NY (US); Ethan Selfridge, New York, NY (US); Biju Mathews, New York, NY (US); Sujit Mathi, New York, NY (US); Joseph Bradley, Seattle, WA (US)

(73) Assignee: LIVEPERSON, INC., New York, NY (US)

(21) Appl. No.: 19/002,515

(22) Filed: Dec. 26, 2024

Related U.S. Application Data
(60) Provisional application No. 63/615,376, filed on Dec. 28, 2023.

(51) Int. Cl. G06F 16/34; G06F 40/289

(52) U.S. Cl. CPC G06F 16/345; G06F 40/289

(57) ABSTRACT

A device may receive, at a server system, a free-form query. The device may select two-way communication history records from a database associated with the free-form query to identify selected history records. The device may generate individual summaries of individual history records of the selected history records by processing a set of corresponding individual history records using a chunking algorithm, constructing language responses from outputs of the chunking algorithm using a large language model, and aggregating the language responses. The device may process the language responses using the large language model to generate an individual summary for corresponding individual history records.

### CROSS REFERENCE TO RELATED APPLICATIONS

This application claims priority to U.S. Provisional Application 63/615,376 filed Dec. 28, 2023, the entire content of which is incorporated herein by reference for all purposes.

### FIELD

The present disclosure relates generally to data processing and summarizing using large language model (LLM) based artificial-intelligence (AI). More specifically, techniques are provided to summarize data sets with data sampling, using LLM analysis to summarize sampled data, and using LLM analysis to summarize sets of LLM generated summaries of the sampled data.

### BACKGROUND

Various language models may be used to analyze communications and generate summaries of information. But some existing summary tools are limited in capability.

### SUMMARY

In some aspects, the techniques described herein relate to a computer-implemented method including: receiving, at a server system, a free-form query; selecting two-way communication history records from a database associated with the free-form query to identify selected history records; and generating individual summaries of individual history records of the selected history records by: processing a set of corresponding individual history records using a chunking algorithm; constructing language responses from outputs of the chunking algorithm using a large language model; aggregating the language responses; and processing the language responses using the large language model to generate an individual summary for corresponding individual history records.

In some aspects, the techniques described herein relate to a computer-implemented method including: accessing history data for a plurality of two-way communications; receiving a natural language query associated with the plurality of two-way communications; generate, using a large language model and the natural language query, a summary of the plurality of two-way communications; and generating, using the large language model and the natural language query, an aggregated response to the natural language query.

In some aspects, the techniques described herein relate to a computer-implemented method including: receiving, at a server system, a free-form query; identifying a plurality of two-way communications associated with the free-form query; selecting a threshold number of two-way communication history records from the plurality of two-way communications to identify selected history records; processing the selected history records using a large language model to generate individual summaries of individual history records of the selected history records; processing the individual summaries to generate an aggregated summary of the selected history records; and generating, using the large language model, the individual summaries, and the aggregated summary, an aggregated response to the free-form query.

In some aspects, the techniques described herein relate to a computer-implemented method including: receiving, at a server system, a free-form query; splitting the free-form query into a summary query and an aggregation query; selecting a set of conversations from a message history database; summarizing individual conversations of the set of conversations using a large language model to generate a plurality of summaries; and aggregating the plurality of summaries using the aggregation query to generate a single aggregation summary for the set of conversations.

In some aspects, aggregating the plurality of summaries further comprises wherein aggregating the plurality of summaries includes dividing the plurality of summaries into groups of summaries having less than a threshold number of summaries per group, generating summaries for individual groups of the groups of summaries, and generating the single aggregation summary from the summaries for individual groups. In some aspects, the techniques described herein relate

to a system including: a memory; and one or more processors coupled to the memory and configured to perform operations including: receiving, at a server system, a free-form query; selecting two-way communication history records from a database associated with the free-form query to identify selected history records; and generating individual summaries of individual history records of the selected history records by: processing a set of corresponding individual history records using a chunking algorithm; constructing language responses from outputs of the chunking algorithm using a large language model; aggregating the language responses; and processing the language responses using the large language model to generate an individual summary for corresponding individual history records.

In some aspects, the techniques described herein relate to a non-transitory computer-readable storage medium including instructions that, when executed by one or more processors of a computing system, cause the computing system to perform operations including: receiving, at a server system, a free-form query; selecting two-way communication history records from a database associated with the free-form query to identify selected history records; and generating individual summaries of individual history records of the selected history records by: processing a set of corresponding individual history records using a chunking algorithm; constructing language responses from outputs of the chunking algorithm using a large language model; aggregating the language responses; and processing the language responses using the large language model to generate an individual summary for corresponding individual history records.

### BRIEF DESCRIPTION OF THE DRAWINGS

The present disclosure is described in conjunction with the appended Figures:

FIG. 1 shows an example embodiment of a network interaction system in accordance with some aspects of the present technology;

FIG. 2 shows an example embodiment of a network interaction system in accordance with some aspects of the present technology;

FIGS. 3A, 3B, and 3C show example embodiments of a network interaction system that includes a connection management system in accordance with some aspects of the present technology;

FIG. 4 shows a representation of a protocol-stack mapping of connection components' operation in accordance with some aspects of the present technology;

FIG. 5 represents a multi-device communication exchange system embodiment in accordance with some aspects of the present technology;

FIG. 6 shows an example embodiment of a connection management system in accordance with some aspects of the present technology;

FIG. 7 shows an example embodiment of a data management engine in accordance with some aspects of the present technology;

FIG. 8 shows a flowchart of a method embodiment in accordance with some aspects of the present technology;

FIG. 9A shows a flowchart of a method embodiment in accordance with some aspects of the present technology;

FIG. 9B shows a flowchart of a method embodiment in accordance with some aspects of the present technology;

FIG. 9C shows a flowchart of a method embodiment in accordance with some aspects of the present technology;

FIG. 9D shows a flowchart of a method embodiment in accordance with some aspects of the present technology;

FIG. 10A shows a flowchart of a method embodiment in accordance with some aspects of the present technology;

FIG. 10B shows a flowchart of a method embodiment in accordance with some aspects of the present technology;

FIGS. 11A-11D show flowcharts of methods in accordance with some aspects of the present technology;

FIG. 12A show example elements of an interface for providing summary data generated using an LLM based AI system in accordance with some aspects of the present technology;

FIG. 12B show example elements of an interface for providing summary data generated using an LLM based AI system in accordance with some aspects of the present technology;

FIG. 12C show example elements of an interface for providing summary data generated using an LLM based AI system in accordance with some aspects of the present technology; and

FIG. 13 illustrates an example computing device that can be used to implement aspects of an insight driven communication system in accordance with some implementations of the present technology.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides examples and is not intended to limit the scope, applicability or configuration of the disclosure. Rather, the ensuing description of the examples will provide those skilled in the art with an enabling description for implementing examples. It is understood that various changes can be made in the function and arrangement of elements without departing from the spirit and scope as set forth in the appended claims.

Examples described herein relate to computing systems configured to analyze communications and to generate summaries of the information. Certain aspects use a text-based user-driven query to initiate an analysis of a sample of communication records (e.g., communication records for customers interacting with representatives of a merchant, brand, etc.) and generate answers to the user-driven query using large language models. Some can particularly generate summaries of sets of messages that are parts of a two-way communication using large language models, and can then use these summaries to generate an aggregated summary (e.g., a summary of summaries generated from conversation samples). Such systems can additionally or alternatively use natural language processing (NLP), natural language analysis (NLA), neural networks, and various AI and machine learning tools to analyze data from a communication system and generate summary information via a user interface. Such a user interface may be a simple text interface. In other aspects, more complex graphical interface summaries can be generated in addition to or as an alternative to text summaries.

Such systems can be configured to respond to a wide variety of user inquiries and can provide flexible analysis of large sets of data. Existing summary tools primarily use Large Language Models (LLMs) only for visualization or working with tabular data. Some summary products operate using short pieces of text (e.g., AssemblyAI™ which analyzes single pieces of text or single conversations) or contiguous long texts (e.g., Wordtune™, which summarizes books or other longform sets of text). Aspects described herein can analyze data from tens, hundreds, thousands, or larger sets of independent text (e.g., many text communications) to generate summaries of text sets which may include communications with limited relationship to each other.

Aspects described herein provide a benefit over existing systems with functionality to generate data summaries over many pieces of text, and generating text outputs focusing on business insights to produce conversational summary responses to text questions. Examples described herein improve the operation of devices in a communication system by improving the efficiency of AI and machine-based communications with data sampling, providing improved data analysis functionality with the sampled data, and improving the quality of machine driven communications in such a system. Additionally, user interfaces described herein can improve the operations of devices in a communication system by reducing the processing resources used to generate a set of analysis data and improving the efficiency of associated operations for managing AI assisted communication systems, and by efficiently generating data summaries.

Additional details and context information are provided below.

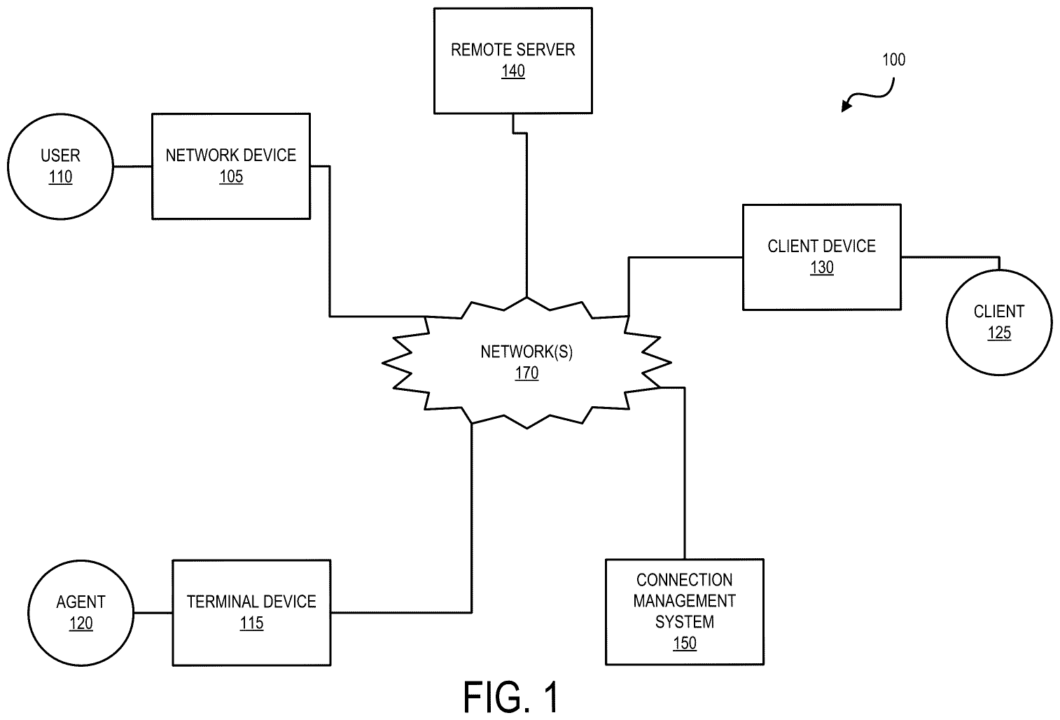

FIG. 1 shows a block diagram of an embodiment of a network interaction system 100 which implements and supports certain embodiments and features described herein. Aspects of the network interaction system 100 can be used to generate data which is analyzed and summarized by AI and/or LLM based analysis and text summary generation systems. Certain embodiments relate to communications generated between a network device 105 (which can be operated by a user 110), and a terminal device 115 (which can be operated by an agent 120) and/or a client device 130 (operated by a client 125), which can be stored as data and analyzed to generate summaries of such communications between many network devices 105, many terminal devices 115, and many client devices 130 (e.g., tens, hundreds, thousands, or more). Aspects described herein can manage and store data in real-time for many such simultaneous communications, and can use machine-based AI/LLM systems to generate or update summaries of data sets while many such communications are occurring and being added to the data sets in real-time.

In some embodiments, a user 110 can be an individual browsing a web site or accessing an online service provided by a remote server 140. In some embodiments, user 110 can be an individual looking to have a service performed on their behalf. Such a service can include having a question answered, operating another device, getting help from an agent with a task or service, conducting a transaction, etc. Data associated with such services can be stored for later analysis and summarization in accordance with aspects described herein.

A client 125 can be an entity that provides, operates, or runs the website or the online service, or individuals employed by or assigned by such an entity to perform the tasks available to a client 125 as described herein.

The agent 120 can be an individual, such as a support agent or sales associate tasked with providing support or information to the user 110 regarding the website or online service (e.g., information about products available at an online store). Out of a large number of agents, a subset of agents may be appropriate for providing support or information for a particular client 125. The agent 120 may be affiliated or not affiliated with the client 125. Each agent can be associated with one or more clients 125. In some non-limiting examples, a user 110 can be an individual shopping an online store from a personal computing device, a client 125 can be a company that sells products online, and an agent 120 can be a sales associate employed by the company. In various embodiments, the user 110, client 125, and agent 120 can be other individuals or entities.

While FIG. 1 shows only a single network device 105, terminal device 115, and client device 130, an interaction system 100 can include multiple or many (e.g., tens, hundreds or thousands) of each of one or more of these types of devices. Similarly, while FIG. 1 shows only a single user 110, agent 120, and client 125, an interaction system 100 can include multiple or many of each of one or more of such entities. Thus, it may be necessary to determine which endpoint is to be selected to communicate with a given network device. Further complicating matters, a remote server 140 may also be configured to receive and respond to select communications with network device 105.

A connection management system 150 can facilitate strategic routing of communications. A communication can include a message with content (e.g., defined based on input from an entity, such as typed or spoken input). The communication can also include additional data, such as data about a transmitting device (e.g., an IP address, account identifier, device type and/or operating system); a destination address; an identifier of a client; an identifier of a webpage or webpage element (e.g., a webpage or webpage element being visited when the communication was generated or otherwise associated with the communication) or online history data; a time (e.g., time of day and/or date); and/or destination address. Other information can be included in the communication. In some embodiments, connection management system 150 routes the entire communication to another device. In some embodiments, connection management system 150 modifies the communication or generates a new communication (e.g., based on the initial communication). The new or modified communication can include the message (or processed version thereof), at least some (or all) of the additional data (e.g., about the transmitting device, webpage or online history and/or time) and/or other data identified by connection management system 150 (e.g., account data associated with a particular account identifier or device). The new or modified communication can include other information as well.

Part of strategic-routing facilitation can include establishing, updating and using one or more connections between network device 105 and one or more terminal devices 115. For example, upon receiving a communication from network device 105, connection management system 150 can estimate to which client (if any) the communication corresponds. Upon identifying a client, connection management system 150 can identify a terminal device 115 associated with the client for communication with network device 105. In some embodiments, the identification can include evaluating a profile of each of a plurality of agents (or experts or delegates), each agent (e.g., agent 120) in the plurality of agents being associated with a terminal device (e.g., terminal device 115). The evaluation can relate to content in a network-device message. The identification of the terminal device 115 can include a technique described, for example, in U.S. application Ser. No. 12/725,799, filed on Mar. 17, 2010, which is hereby incorporated by reference in its entirety for all purposes.

In some embodiments, connection management system 150 can determine whether any connections are established between network device 105 and an endpoint associated with the client (or remote server 140) and, if so, whether such channels are to be used to exchange a series of communications including the communication.

Upon selecting an endpoint to communicate with network device 105, connection management system 150 can establish connections between the network device 105 and the endpoint. In some embodiments, connection management system 150 can transmit a message to the selected endpoint. The message may request an acceptance of a proposed assignment to communicate with a network device 105 or identify that such an assignment has been generated. The message can include information about network device 105 (e.g., IP address, device type, and/or operating system), information about an associated user 110 (e.g., language spoken, duration of having interacted with client, skill level, sentiment, and/or topic preferences), a received communication, code (e.g., a clickable hyperlink) for generating and transmitting a communication to the network device 105, and/or an instruction to generate and transmit a communication to network device 105.

In some embodiments, communications between network device 105 and an endpoint such as a user device can be routed through connection management system 150. Such a configuration can allow connection management system 150 to monitor the communication exchange and to detect issues (e.g., as defined based on rules) such as non-responsiveness of either device or extended latency. Further, such a configuration can facilitate selective or complete storage of communications, which may later be used, for example, to assess a quality of a communication exchange and/or to support learning to update or generate routing rules so as to promote particular post-communication targets. As will be described further herein, such configurations can facilitate management of conversations between user 110 and one or more endpoints.

In some embodiments, connection management system 150 can monitor the communication exchange in real-time and perform automated actions (e.g., rule-based actions, artificial intelligence originated actions, etc.) based on the live communications. For example, when connection management system 150 determines that a communication relates to a particular product, connection management system 150 can transmit an additional message to the endpoint containing additional information about the product (e.g., quantity of products in stock, links to support documents related to the product, or other information about the product or similar products).

In some embodiments, a designated endpoint can communicate with network device 105 without relaying communications through connection management system 150. One or both devices 105, 115 may (or may not) report particular communication metrics or content to connection management system 150 to facilitate communication monitoring and/or data storage.

As mentioned, connection management system 150 may route select communications to a remote server 140. Remote server 140 can be configured to provide information in a predetermined manner. For example, remote server 140 may access defined one or more text passages, voice recording and/or files to transmit in response to a communication. Remote server 140 may select a particular text passage, recording or file based on, for example, an analysis of a received communication (e.g., a semantic or mapping analysis).

Routing and/or other determinations or processing performed at connection management system 150 can be performed based on rules and/or data at least partly defined by or provided by one or more client devices 130. For example, client device 130 may transmit a communication that identifies a prioritization of agents, terminal-device types, and/or topic/skill matching. As another example, client device 130 may identify one or more weights to apply to various variables potentially impacting routing determinations (e.g., language compatibility, predicted response time, device type and capabilities, and/or terminal-device load balancing). It will be appreciated that which terminal devices and/or agents are to be associated with a client may be dynamic. Communications from client device 130 and/or terminal devices 115 may provide information indicating that a given terminal device and/or agent is to be added or removed as one associated with a client. For example, client device 130 can transmit a communication with IP address and an indication as to whether a terminal device with the address is to be added or removed from a list identifying client-associated terminal devices.

Each communication (e.g., between devices, between a device and connection management system 150, between remote server 140 and connection management system 150 or between remote server 140 and a device) can occur over one or more networks 170. Any combination of open or closed networks can be included in the one or more networks 170. Examples of suitable networks include the Internet, a personal area network, a local area network (LAN), a wide area network (WAN), or a wireless local area network (WLAN). Other networks may be suitable as well. The one or more networks 170 can be incorporated entirely within or can include an intranet, an extranet, or a combination thereof. In some embodiments, a network in the one or more networks 170 includes a short-range communication channel, such as a Bluetooth or a Bluetooth Low Energy channel. In one embodiment, communications between two or more systems and/or devices can be achieved by a secure communications protocol, such as secure sockets layer (SSL) or transport layer security (TLS). In addition, data and/or transactional details may be encrypted based on any convenient, known, or to be developed manner, such as, but not limited to, Data Encryption Standard (DES), Triple DES, Rivest-Shamir-Adleman encryption (RSA), Blowfish encryption, Advanced Encryption Standard (AES), CAST-128, CAST-256, Decorrelated Fast Cipher (DFC), Tiny Encryption Algorithm (TEA), extended TEA (XTEA), Corrected Block TEA (XXTEA), and/or RC5, etc.

A network device 105, terminal device 115, and/or client device 130 can include, for example, a portable electronic device (e.g., a smart phone, tablet, laptop computer, or smart wearable device) or a non-portable electronic device (e.g., one or more desktop computers, smart appliances, servers, and/or processors). Connection management system 150 can be separately housed from network, terminal, IOT and client devices or may be part of one or more such devices (e.g., via installation of an application on a device). Remote server 140 may be separately housed from each device and connection management system 150 and/or may be part of another device or system. While each device, server and system in FIG. 1 is shown as a single device, it will be appreciated that multiple devices may instead be used. For example, a set of network devices can be used to transmit various communications from a single user, or remote server 140 may include a server stack.

A software agent or application may be installed on and/or executable on a depicted device, system or server. In one instance, the software agent or application is configured such that various depicted elements can act in complementary manners. For example, a software agent on a device can be configured to collect and transmit data about device usage to a separate connection management system, and a software application on the separate connection management system can be configured to receive and process the data.

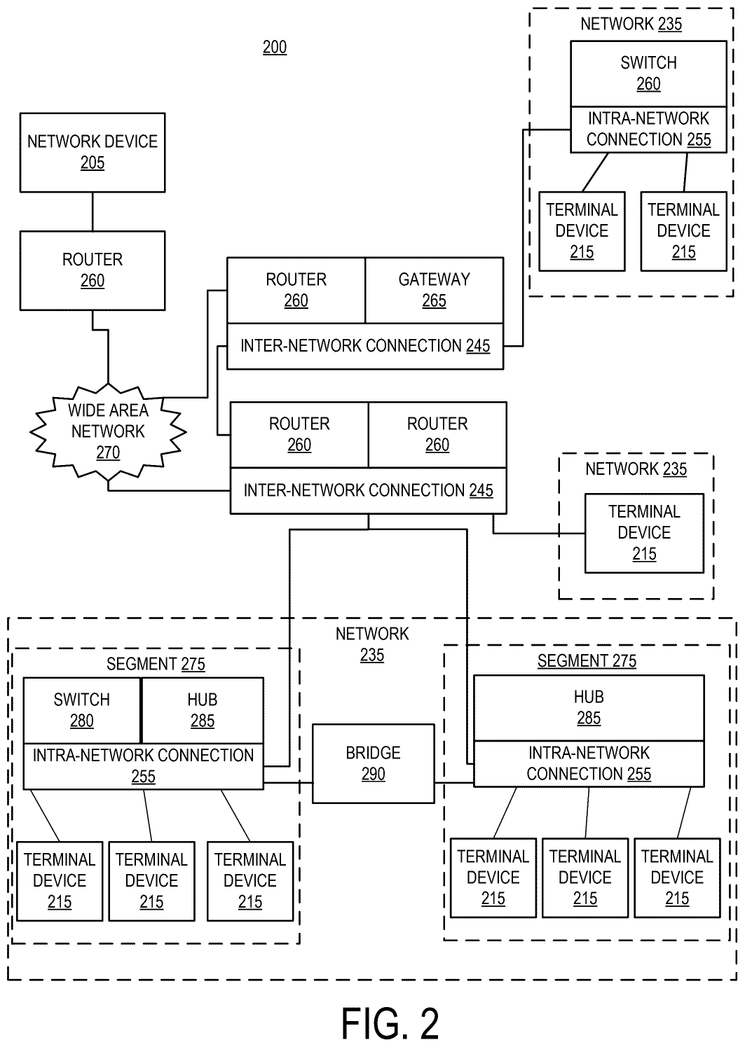

FIG. 2 shows a block diagram of another embodiment of a network interaction system 200. Generally, FIG. 2 illustrates a variety of components configured and arranged to enable a network device 205 to communicate with one or more terminal devices 215. The depicted instance includes nine terminal devices 215 included in three local-area networks 235. As indicated above, such a system can generate conversation data that can be stored for analysis by AI/LLM systems in accordance with aspects detailed herein.

In some embodiments, a communication from network device 205 includes destination data (e.g., a destination IP address) that at least partly or entirely indicates which terminal device is to receive the communication. Network interaction system 200 can include one or more inter-network connection components 245 and/or one or more intra-network connection components 255 that can process the destination data and facilitate appropriate routing.

Each inter-network connection component 245 can be connected to a plurality of networks 235 and can have multiple network cards installed (e.g., each card connected to a different network). For example, an inter-network connection component 245 can be connected to a wide-area network 270 (e.g., the Internet) and one or more local-area networks 235. In the depicted instance, in order for a communication to be transmitted from network device 205 to any of the terminal devices, in the depicted system, the communication must be handled by multiple inter-network connection components 245.

When an inter-network connection component 245 receives a communication (or a set of packets corresponding to the communication), inter-network connection component 245 can determine at least part of a route to pass the communication to a network associated with a destination. The route can be determined using, for example, a routing table (e.g., stored at the router), which can include one or more routes that are pre-defined, generated based on an incoming message (e.g., from another router or from another device) or learned.

Examples of inter-network connection components 245 include a router 260 and a gateway 265. An inter-network connection component 245 (e.g., gateway 265) may be configured to convert between network systems or protocols. For example, gateway 265 may facilitate communication between Transmission Control Protocol/Internet Protocol (TCP/IP) and Internetwork Packet Exchange/Sequenced Packet Exchange (IPX/SPX) devices.

Upon receiving a communication at a local-area network 235, further routing may still need to be performed. Such intra-network routing can be performed via an intra-network connection component 255, such as a switch 280 or hub 285. Each intra-network connection component 255 can be connected to (e.g., wirelessly or wired, such as via an Ethernet cable) multiple terminal devices 215. Hub 285 can be configured to repeat all received communications to each device to which it is connected. Each terminal device can then evaluate each communication to determine whether the terminal device is the destination device or whether the communication is to be ignored. Switch 280 can be configured to selectively direct communications to only the destination terminal device.

In some embodiments, a local-area network 235 can be divided into multiple segments, each of which can be associated with independent firewalls, security rules and network protocols. An intra-network connection component 255 can be provided in each of one, more or all segments to facilitate intra-segment routing. A bridge 290 can be configured to route communications across segments 275.

To appropriately route communications across or within networks, various components analyze destination data in the communications. For example, such data can indicate which network a communication is to be routed to, which device within a network a communication is to be routed to or which communications a terminal device is to process (versus ignore). However, In some embodiments, it is not immediately apparent which terminal device (or even which network) is to participate in a communication from a network device.

To illustrate, a set of terminal devices may be configured so as to provide similar types of responsive communications. Thus, it may be expected that a query in a communication from a network device may be responded to in similar manners regardless to which network device the communication is routed. While this assumption may be true at a high level, various details pertaining to terminal devices can give rise to particular routings being advantageous as compared to others. For example, terminal devices in the set may differ from each other with respect to (for example) which communication channels are supported, geographic and/or network proximity to a network device and/or characteristics of associated agents (e.g., knowledge bases, experience, languages spoken, availability, general personality or sentiment, etc.). Accordingly, select routings may facilitate faster responses that more accurately and/or completely respond to a network-device communication. A complication is that static routings mapping network devices to terminal devices may fail to account for variations in communication topics, channel types, agent availability, and so on.

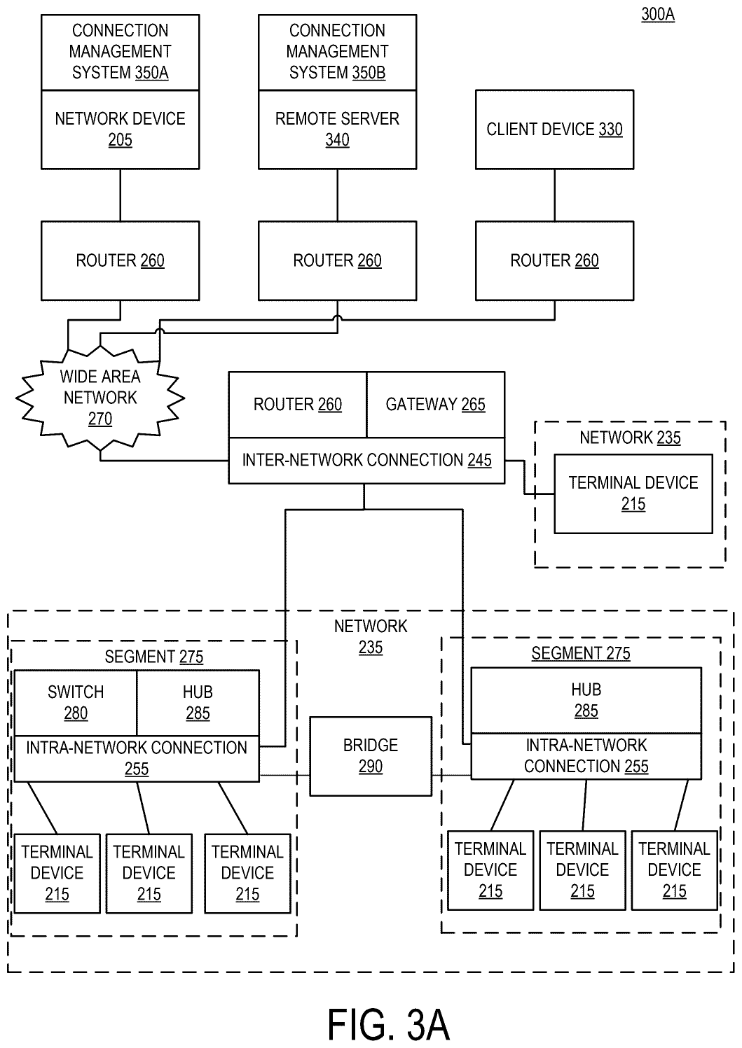

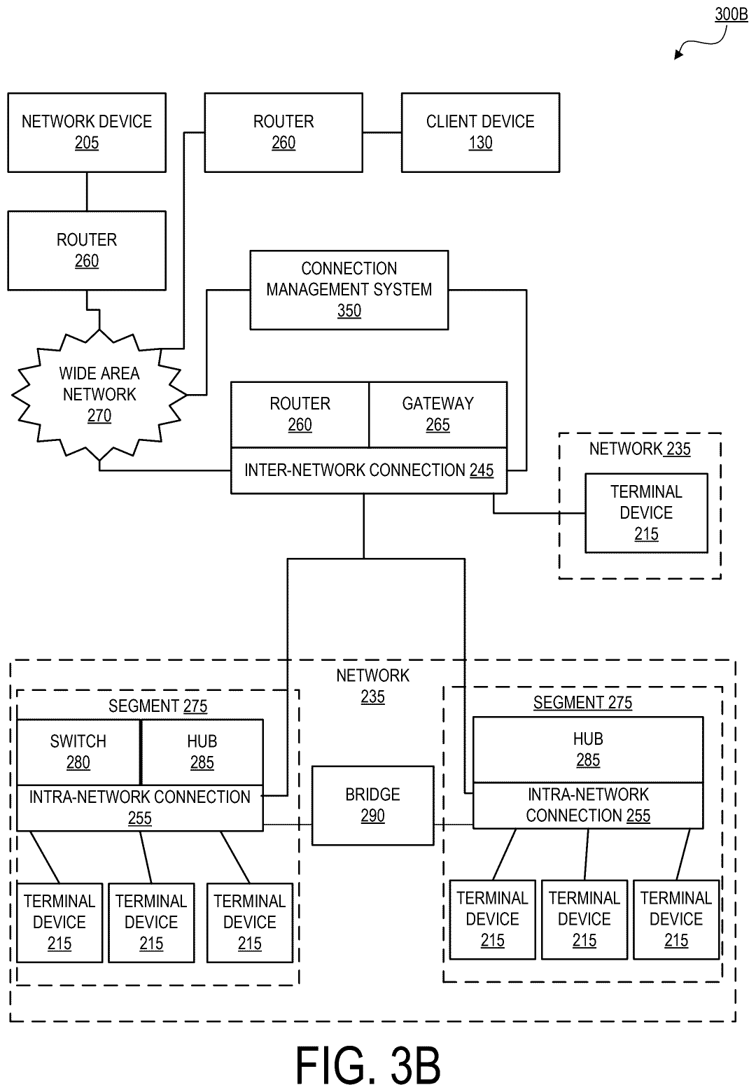

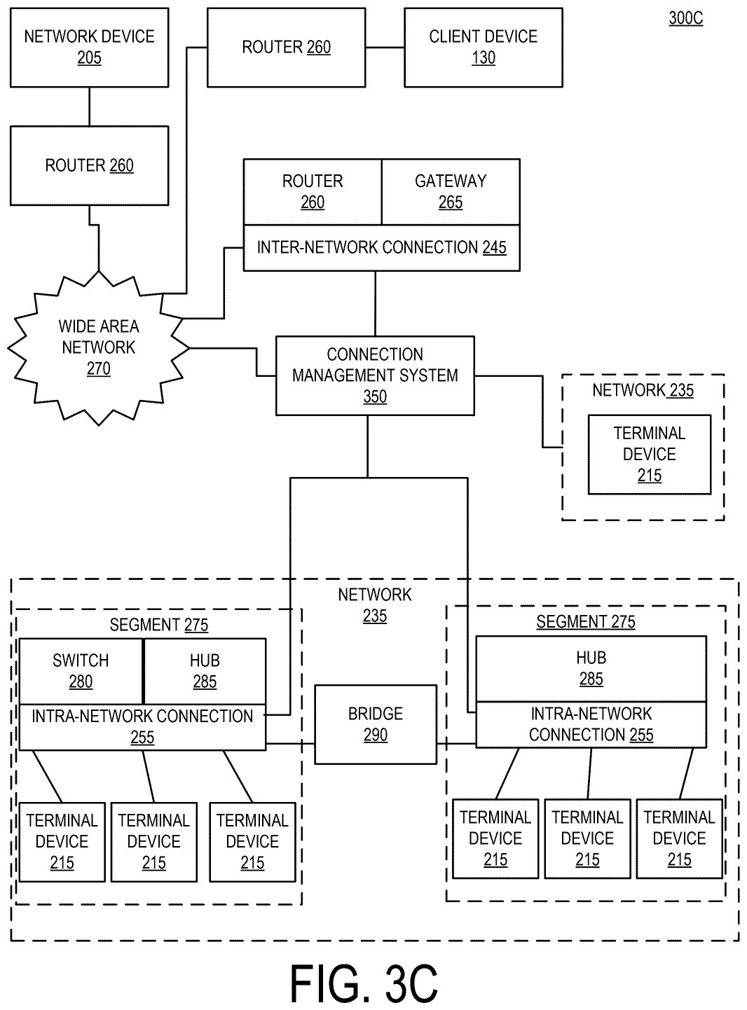

FIGS. 3A, 3B, 3C show block diagrams of other embodiments of a network interaction systems 300a, 300b, 300c that includes a connection management system 350, including example connection management systems 350a and 350b. Each of the depicted systems 300a, 300b, 300c show only two local-area networks 235 for simplicity, though it can be appreciated that embodiments can be extended to expand the number of local-area networks. Each of systems 300a, 300b, 300c include a connection management system 150, which can identify which terminal device is to communicate with network device 205, can establish and manage (e.g., maintain or close) connections, can determine whether and when to re-route communications in an exchange, and so on. Thus, connection management system 150 can be configured to dynamically, and in real-time, evaluate communications, agent availability, capabilities of terminal devices or agents, and so on, to influence routing determinations. Any data passing through such a system can be included with stored conversation data that can be analyzed and summarized by AI/LLM systems in accordance with aspects detailed herein. For example, metadata such as communication times, intent or sentiment analysis data (e.g., generated from context analysis or metadata generated by a party to a conversation or tools used in conjunction with a conversation) can be used in generation of summary data in accordance with aspects described herein.

In FIG. 3A, connection management system 350 is associated with each of network device 205 and a remote server 340 (e.g., connection management system 350a is associated with network device 205 and connection management system 350b is associated with remote server 340). For example, connection management system 350a and/or connection management system 350b can be installed or stored as an application on each of network device 205 and remote server 340, respectively. Execution of the application(s) can facilitate, for example, a communication between network device 205 and remote server 340 to identify a terminal device 215 selected to participate in a communication exchange with network device 205. The identification can be made based on one or more factors disclosed herein (e.g., availability, matching between a communication's topic/level of detail with agents' or terminal devices' knowledge bases, predicted latency, channel-type availability, and so on).

A client device 330 can provide client data indicating how routing determinations are to be made. For example, such data can include: indications as to how particular characteristics are to be weighted or matched or constraints or biases (e.g., pertaining to load balancing or predicted response latency). Client data can also include specifications related to when communication channels are to be established (or closed) or when communications are to be re-routed to a different network device. Client data can be used to define various client-specific rules, such as rules for communication routing and so on.

Connection management system 150b executing on remote server 340 can monitor various metrics pertaining to terminal devices (e.g., pertaining to a given client), such as which communication channels are supported, geographic and/or network proximity to a network device, communication latency and/or stability with the terminal device, a type of the terminal device, a capability of the terminal device, whether the terminal device (or agent) has communicated with a given network device (or user) before and/or characteristics of associated agents (e.g., knowledge bases, experience, languages spoken, availability, general personality or sentiment, etc.). Accordingly, connection management system 150b may be enabled to select routings to facilitate faster responses that more accurately and/or completely respond to a network-device communication based on the metrics.

In the example depicted in FIG. 3A, a communication exchange between network device 205 and remote server 340 can facilitate early identification of a destination address. Network device 205 may then use the destination address to direct subsequent communications. For example, network device 205 may send an initial communication to remote server 340 (e.g., via one or more inter-network connections and a wide-area network), and remote server 340 may identify one or more corresponding clients. Remote server 340 may then identify a set of terminal devices associated with the one or more corresponding clients and collect metrics for those terminal devices. The metrics can be evaluated (e.g., by remote server 340) so as to select a terminal device to involve in a communication exchange, and information pertaining to the terminal device (e.g., an IP address) can be sent to network device 205. In some embodiments, remote server 340 may continuously or periodically collect and evaluate metrics for various terminal devices and store evaluation results in a data store. In such embodiments, upon identifying a set of terminal devices associated with the one or more corresponding clients, remote server 340 can access the stored evaluation results from the data store and select a terminal device to involve in the communication exchange based on the stored evaluation results.

In FIG. 3B, connection management system 150 can be configured to serve as a relay and/or destination address. Thus, for example, a set of network devices 205 may transmit communications, each identifying connection management system 150 as a destination. Connection management system 150 can receive each communication and can concurrently monitor a set of terminal devices (e.g., so as to generate metrics for each terminal device). Based on the monitoring and a rule, connection management system 150 can identify a terminal device 215 to which it may relay each communication. Depending on the embodiment, terminal device communications may similarly be directed to a consistent destination (e.g., of connection management system 150) for further relaying, or terminal devices may begin communicating directly with corresponding network devices. These embodiments can facilitate efficient routing and thorough communication monitoring.

The embodiment depicted in FIG. 3C is similar to that in FIG. 3B. However, in some embodiments, connection management system 150 is directly connected to intra-network components (e.g., terminal devices, intra-network connections, or other).

It will be appreciated that many variations of FIGS. 3A-3C are contemplated. For example, connection management system 150 may be associated with a connection component (e.g., inter-network connection component 245 or intra-network connection component 255) such that an application corresponding to connection management system 150 (or part thereof) is installed on the component. The application may, for example, perform independently or by communicating with one or more similar or complementary applications (e.g., executing on one or more other components, network devices or remote servers).

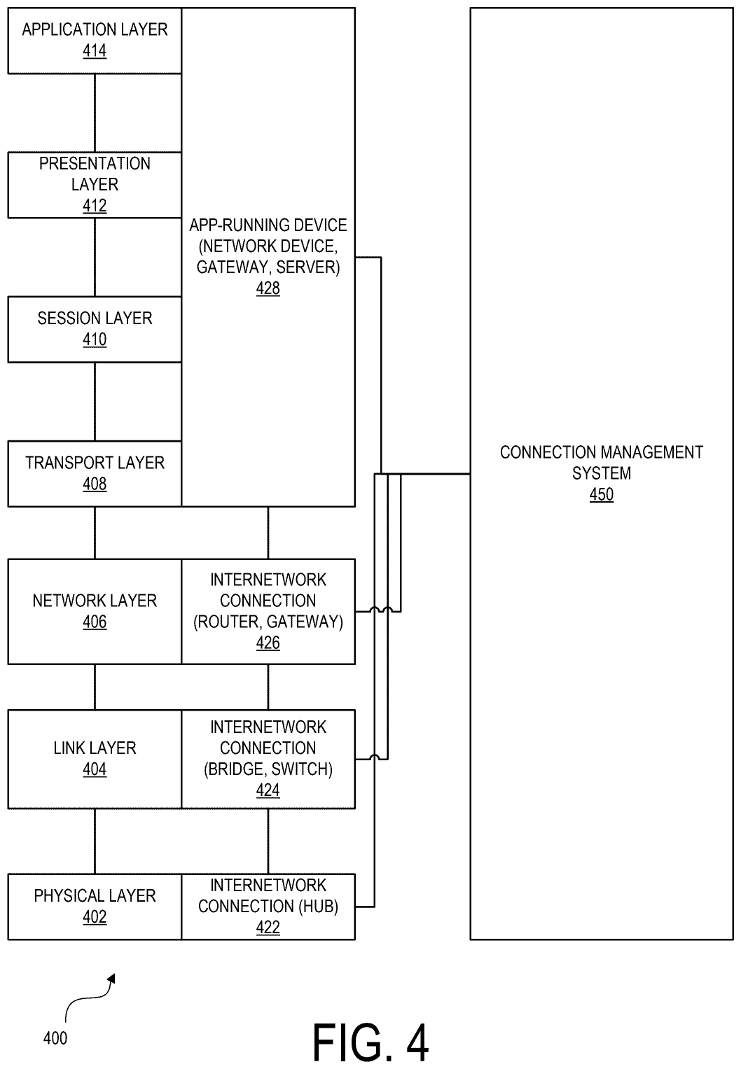

FIG. 4 shows a representation of a protocol-stack mapping 400 of an environment including a connection management system 450 that can be used with AI/LLM summary generation in accordance with aspects described herein. More specifically, FIG. 4 identifies a layer of operation in an Open Systems Interaction (OSI) model that corresponds to various connection components.

The OSI model can include multiple logical layers 402-414. The layers are arranged in an ordered stack, such that layers 402-412 each serve a higher level and layers 404-414 are each served by a lower layer. The OSI model includes a physical layer 402. Physical layer 402 can define parameters for physical communication (e.g., electrical, optical, or electromagnetic). Physical layer 402 also defines connection management protocols, such as protocols to establish and close connections. Physical layer 402 can further define a flow-control protocol and a transmission mode.

A link layer 404 can manage node-to-node communications. Link layer 404 can detect and correct errors (e.g., transmission errors in the physical layer 402) and manage access permissions. Link layer 404 can include a media access control (MAC) layer and logical link control (LLC) layer.

A network layer 406 can coordinate transferring data (e.g., of variable length) across nodes in a same network (e.g., as datagrams). Network layer 406 can convert a logical network address to a physical machine address.

A transport layer 408 can manage transmission and receipt quality. Transport layer 408 can provide a protocol for transferring data, such as a Transmission Control Protocol (TCP). Transport layer 408 can perform segmentation/desegmentation of data packets for transmission and can detect and account for transmission errors occurring in layers 402, 404,406. A session layer 410 can initiate, maintain and terminate connections between local and remote applications. Sessions may be used as part of remote-procedure interactions. A presentation layer 412 can encrypt, decrypt and format data based on data types known to be accepted by an application or network layer.

An application layer 414 can interact with software applications that control or manage communications. Via such applications, application layer 414 can (for example) identify destinations, local resource states or availability and/or communication content or formatting. Various layers 402, 404, 406, 408, 410, 412, 414 can perform other functions as available and applicable.

Intra-network connection components 422, 424 are shown to operate in physical layer 402 and link layer 404. More specifically, a hub can operate in the physical layer, such that operations can be controlled with respect to receipts and transmissions of communications. Because hubs lack the ability to address communications or filter data, they possess little to no capability to operate in higher levels. Switches, meanwhile, can operate in link layer 404, as they are capable of filtering communication frames based on addresses (e.g., MAC addresses).

Meanwhile, inter-network connection components 426, 428 are shown to operate on higher levels (e.g., layers 406, 408, 410, 412, 414). For example, routers can filter communication data packets based on addresses (e.g., IP addresses). Routers can forward packets to particular ports based on the address, so as to direct the packets to an appropriate network. Gateways can operate at the network layer and above, perform similar filtering and directing and further translation of data (e.g., across protocols or architectures).

A connection management system 450 can interact with and/or operate on, in various embodiments, one, more, all or any of the various layers. For example, connection management system 450 can interact with a hub so as to dynamically adjust which terminal devices the hub communicates. As another example, connection management system 450 can communicate with a bridge, switch, router or gateway so as to influence which terminal device the component selects as a destination (e.g., MAC, logical or physical) address. By way of further examples, a connection management system 450 can monitor, control, or direct segmentation of data packets on transport layer 408, session duration on session layer 410, and/or encryption and/or compression on presentation layer 412. In some embodiments, connection management system 450 can interact with various layers by exchanging communications with (e.g., sending commands to) equipment operating on a particular layer (e.g., a switch operating on link layer 404), by routing or modifying existing communications (e.g., between a network device and a terminal device) in a particular manner, and/or by generating new communications containing particular information (e.g., new destination addresses) based on the existing communication. Thus, connection management system 450 can influence communication routing and channel establishment (or maintenance or termination) via interaction with a variety of devices and/or via influencing operating at a variety of protocol-stack layers.

Additionally, in accordance with aspects described herein, the connection management system 450 can store conversation data along with information (e.g., metadata) about a conversation, such as brand, product, or merchant information associated with conversation data that may not be present or derivable directly from the data (e.g., as associated with information about how the conversation was initiated or source systems which transferred the conversation to the environment including the connection management system 450). In some aspects, the connection management system 450 can include AI/LLM systems that analyze conversation data. In other aspects, the connection management system can facilitate storage of conversation data and/or connection to separate AI/LLM systems used to analyze conversation data in accordance with aspects described herein.

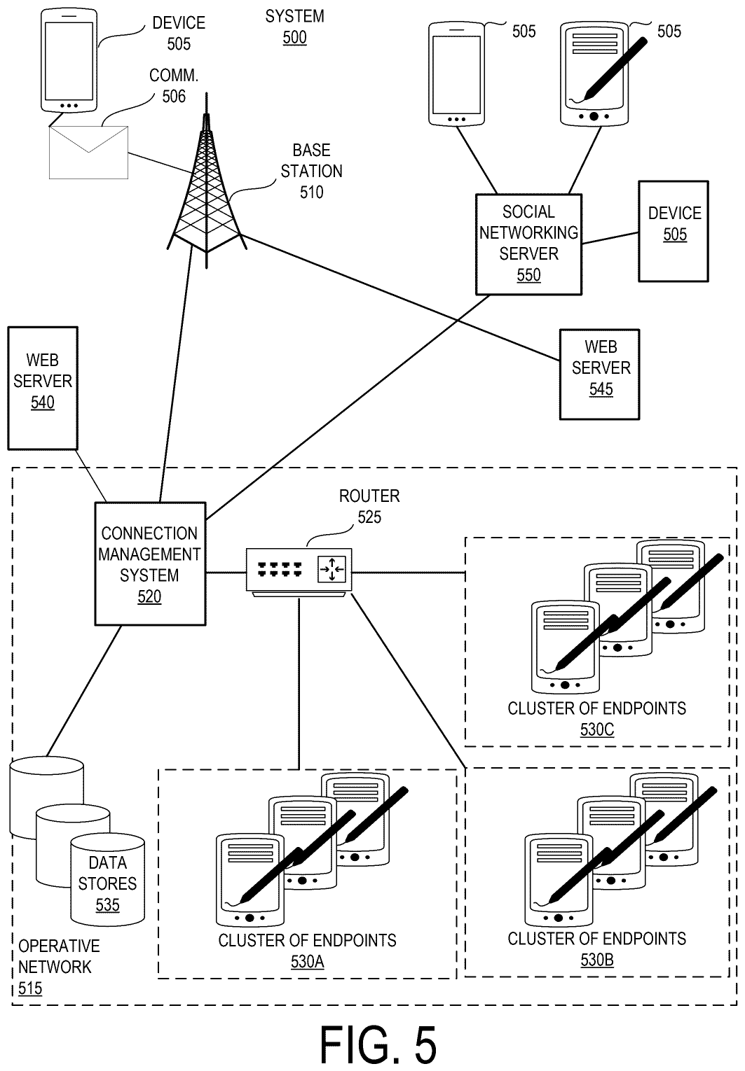

FIG. 5 represents a multi-device communication exchange system 500 according to an embodiment. System 500 includes a network device 505 configured to communicate (e.g. via communications 506) with a variety of types of endpoints over a variety of types of communication channels, and as described above, can be used with AI/LLM systems for generating summaries of conversation data in accordance with aspects described herein.

In the depicted instance, network device 505 can transmit a communication over a cellular network (e.g., via a base station 510). The communication can be routed to an operative network 515. Operative network 515 can include a connection management system 150 that receives the communication and identifies which endpoint is to respond to the communication. Such determination can depend on identifying a client to which that communication pertains (e.g., based on a content analysis or user input indicative of the client) and determining one or more metrics for each of one or more endpoints associated with the client. For example, in FIG. 5, each cluster of endpoints 530A, 530B, and 530C can correspond to a different client. The endpoints may be geographically co-located or dispersed geographically. The metrics may be determined based on stored or learned data and/or real-time monitoring (e.g., based on availability).

Connection management system 520 can communicate with various endpoints via one or more routers 525 or other inter-network or intra-network connection components. Connection management system 520 may collect, analyze and/or store data from or pertaining to communications, terminal-device operations, client rules, and/or user-associated actions (e.g., online activity, account data, purchase history, etc.) at one or more data stores. Such data may influence communication routing.

Notably, various other devices can further be used to influence communication routing and/or processing. For example, in the depicted instance, connection management system 520 also is connected to a web server 540 and database(s) 535. Thus, connection management system 520 can retrieve data of interest, such as technical product details, news, current product offerings, current or predicted weather, and so on.

Network device 505 may also be connected to a web server (e.g., including a streaming web server 545). In some embodiments, communication with such a server provided an initial option to initiate a communication exchange with connection management system 150. For example, network device 505 may detect that, while visiting a particular webpage, a communication opportunity is available and such an option can be presented.

In some embodiments, one or more elements of communication system 500 can also be connected to a social-networking server 550. Social networking server 550 can aggregate data received from a variety of user devices. Thus, for example, connection management system 150 may be able to estimate a general (or user-specific) insight towards a given topic or estimate a general behavior of a given user or class of users. Social networking server 550 can also maintain a social graphs for one or more users. A social graph can consist of first level connections (direct connections) of a social user, and additional levels of connections (indirect connections through the user's direct connections).

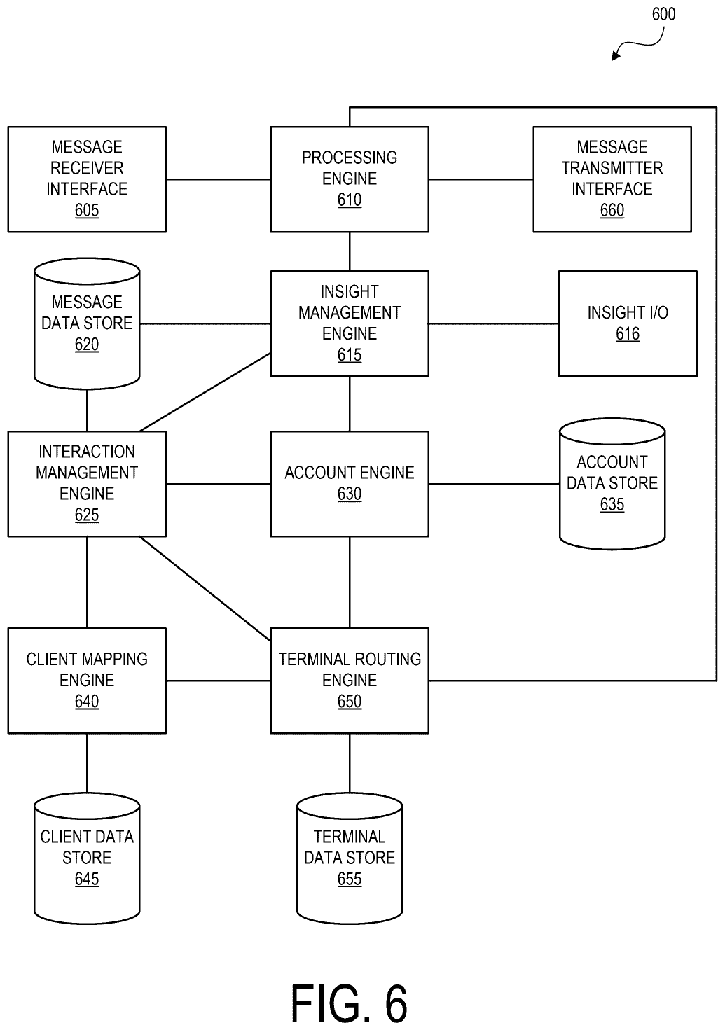

FIG. 6 shows a block diagram of an embodiment of a connection management system 600. Connection management system 600 can, in some examples, be used as connection management system 150, 520, or any other such connection management system. A message receiver interface 605 can receive a message. In some embodiments, the message can be received, for example, as part of a communication transmitted by a source device (e.g., housed separately from connection management system 150 or within a same housing), such as a network device or endpoint. In some embodiments, the communication can be part of a series of communications or a communication exchange, which can include a series of messages or communication exchange being routed between two devices (e.g., a network device and endpoint). This message or communication exchange may be part of and/or may define an interaction between the devices. A communication channel or operative channel can include one or more protocols (e.g., routing protocols, task-assigning protocols and/or addressing protocols) used to facilitate routing and a communication exchange between the devices.

In some embodiments, the message can include a message generated based on inputs received at an user interface. For example, the message can include a message that was generated based on button or key presses or recorded speech signals, or speech to text software. In one instance, the message includes an generated message, such as one generated upon detecting that a network device is presenting a particular app page or webpage or has provided a particular input command (e.g., key sequence). The message can include an instruction or request, such as one to initiate a communication exchange.

In some embodiments, the message can be a natural language communication, whether spoken or typed. A natural language communication, as used herein, refers to ordinary use of a language used to communicate amongst humans, and is contrasted with use of language defined by a protocol required for communicating with a specific virtual assistant or artificial intelligence tool. A natural language communication should not require constraints such as the use of a wake word to alert an artificial intelligence tool that a communication is addressed to the artificial intelligence. Additionally, a natural language communication should not require the user to identify particular key words, specific phrases, or explicitly name a service in order to understand how to service the communication. In some embodiments, natural language may include emoticons and other forms of modern communication.

While the present technology utilizes natural language communications, the communications can identify particular key words, specific phrases, or explicitly name a service. For example, the message can include or be associated with an identifier of a client. For example, the message can explicitly identify the client (or a device associated with the client); the message can include or be associated with a webpage or app associated with the client; the message can include or be associated with a destination address associated with a client; or the message can include or be associated with an identification of an item (e.g., product) or service associated with the client (e.g., being offered for sale by the client, having been sold by the client or being one that the client services). To illustrate, a network device may be presenting an app page of a particular client, which may offer an option to transmit a communication to an agent. Upon receiving user input corresponding to a message, a communication may be generated to include the message and an identifier of the particular client.

A processing engine 610 may process a received communication and/or message. Processing can include, for example, extracting one or more particular data elements (e.g., a message, a client identifier, a network-device identifier, an account identifier, and so on). Processing can include transforming a formatting or communication type (e.g., to be compatible with a particular device type, operating system, communication-channel type, protocol and/or network).

An insight management engine 615 may assess the (e.g., extracted or received) message. The insight management engine, as part of an assessment, can add any appropriate metadata, such as categorization data or information about a user, client, or agent associated with a communication. Each communication can further be associated with a conversation (e.g., groups of communications), and added to the message data store 620. Any message can then be accessed from the message data store 620 via the insight management engine 615. Additional examples of metadata include, but are not limited to, communication topic, sentiment, complexity, and urgency. A topic can include, but is not limited to, a subject, a product, a service, a technical issue, a use question, a complaint, a refund request or a purchase request, etc. Metadata can be determined, for example, based on a semantic analysis of a message (e.g., by identifying keywords, sentence structures, repeated words, punctuation characters and/or non-article words); user input (e.g., having selected one or more categories); and/or message-associated statistics (e.g., typing speed and/or response latency). Aspects of insight management engine 615 can use machine learning to generate and revise systems for associating incoming communications (e.g. text) from a user with an insight category. For example, machine learning models can use previous data and results of associations between words and phrases in incoming communications as well as natural language data from current and historical communications to generate and update associations between words and insight categories. This can be done with any combination of supervised learning with constructed data sets and historical data, unsupervised learning based on expectation or projection models for current routing paths in a system and system use targets. Any such data can be used in operations for natural language processing (e.g. natural language understanding, natural language inference, etc.) to generate natural language data or to update machine learning models. Such data can then be used by the client systems or shared with applications running on a network device or on a server to improve dynamic message processing (e.g. improved insight indicator data results or response message generation). In some examples, convolutional neural networks can be used with sets of incoming words and phrases along with output insight categories. Such a neural network can be trained with input words and phrases and output correlations to insight categories. Real-time system operations can then use instances of such a neural network to generate data on associations between incoming user communications and words in a user communication and insight categories in a system. Based on the outputs of such a neural network, an insight category can be assigned to a user or user account involved in a communication, and associated actions can be assigned. In some implementations, the neural network settings can be modified with real-time dynamic feedback from usage to shift associations between words in user communications and insight categories and actions selected based on these words. These selections can be probabilistic, and so the AI and machine learning systems can track shifts in user expectations by integrating user feedback and usage data to improve system performance. For example, when a user is directed to an endpoint action for a particular insight category or subcategory, the user can provide a feedback communication indicating that the user is looking for a different action. This can be used as real-time feedback in a system to shift the probabilities and annotations associated with future insight category assignments.

This message can be accessed from a message data store 620, which manages messages received by interface 605 and assessed by insight management engine 615. For example, a free-form text query can be received at the insight management engine 615 via insight input/output 616. The insight management engine 615 can then sample relevant data from the message data store 620, and summarize the sampled data using AI/LLM systems coupled to the insight management engine 615 as described in more detail further below.

In some embodiments, an insight category can be clarified by engaging user 110 in a conversation that can include clarifying questions, or simply requesting additional information. Just as above, various machine learning and AI systems can be used to generate and update systems for responding to a user. For example, in some systems, each insight metadata category and sub-category can have a different associated convolutional neural network. In some examples, an action taken in response to processing words from a user is to associate an insight metadata category and a neural network for the insight metadata category to a communication with a user, and to process the user communications using the assigned neural network. As described herein, multiple different neural networks can be used in the course of a conversation (e.g. multiple back and forth communications between a user and a system), and data for such communications can be used in machine learning operations to update the neural networks or other systems used for future interactions with users and operations to associate insight metadata categories and actions with words from a user communication. Usage data by users can be used to adjust weights in a neural network to improve insight metadata category assignments and track changes in user insight metadata trends (e.g. final user insight metadata results identified at the end of a user conversation with a system as compared with assigned insights based on initial user communications).

An interaction management engine 625 can determine to which endpoint a communication is to be routed and how the receiving and transmitting devices are to communicate. Each of these determinations can depend, for example, on whether a particular network device (or any network device associated with a particular user) has previously communicated with an endpoint in a set of endpoints (e.g., any endpoint associated with connection management system 150 or any endpoint associated with one or more particular clients). In some examples, an interaction management engine 625 is invoked as an action to route a user communication to a different endpoint based on insight metadata categories assigned to a user communication. This can involve updates to an endpoint (e.g. a particular agent or AI resource) being used during a conversation with a user.

In some embodiments, when a network device (or other network device associated with a same user or account) has previously communicated with a given endpoint (e.g., communications with a particular agent or AI system about matters relating to a particular topic or system client or business), communication routing can be generally biased towards the same endpoint. Other factors that may influence routing can include, for example, an inferred or identified user or agent sentiment pertaining to the previous communication; a topic of a present communication (e.g., and an extent to which that relates to a topic of a previous communication and/or a knowledge base associated with one or more endpoints); whether the endpoint is available; and/or a predicted response latency of the endpoint. Such factors may be considered absolutely or relative to similar metrics corresponding to other endpoints. A re-routing rule (e.g., a client-specific or general rule) can indicate how such factors are to be assessed and weighted to determine whether to forego agent consistency. Just as above for insight metadata category assignment, AI analysis can be used to determine re-routing rules in a system. For example, when history data processed by machine learning systems identify no correlation between certain types of user communications and certain re-routing operations, such re-routing operations can be discontinued. By contrast, when such machine learning analysis identifies positive results correlated with re-routing rules, such rules can be emphasized or strengthened, to prioritize re-routing (e.g. dedicating additional systems to re-routing, prioritizing re-routing options in agent assignments, etc.)

When a network device (or other network device associated with a same user or account) has not previously communicated with a given endpoint (e.g., about matters relating to a client), an endpoint selection can be performed based on factors such as, for example, an extent to which various agents' knowledge base corresponds to a communication topic, availability of various agents at a given time and/or over a channel type, types and/or capabilities of endpoints, a language match between a user and agents, and/or a personality analysis. In one instance, a rule can identify how to determine a sub-score to one or more factors such as these and a weight to assign to each score. By combining (e.g., summing) weighted sub-scores, a score for each agent can be determined. An endpoint selection can then be made by comparing endpoints' scores (e.g., to select a high or highest score).

With regard to determining how devices are to communicate, interaction management engine 625 can (for example) determine whether an endpoint is to respond to a communication via (for example) email, online chat, SMS message, voice call, video chat, etc. A communication type can be selected based on, for example, a communication-type priority list (e.g., at least partly defined by a client or user); a type of a communication previously received from the network device (e.g., so as to promote consistency), a complexity of a received message, capabilities of the network device, and/or an availability of one or more endpoints. Appreciably, some communication types will result in real-time communication (e.g., where fast message response is expected), while others can result in asynchronous communication (e.g., where delays (e.g., of several minutes or hours) between messages are acceptable).

In some embodiments, the communication type can be a text messaging or chat application. These communication technologies provide the benefit that no new software needs to be downloaded and executed on users' network devices. In some examples, the communication type can be a voice communication type. In such examples, voice to text systems can be used to process voice communications into words to be analyzed by example systems described herein. In some examples, words analyzed by a system can include words represented by audio data. Thus, as described herein, words can be represented by combinations of symbols stored in memory (e.g. American Standard Code for Information Interchange (ASCII) data) or can be represented by audio data (e.g. data representing sound combinations)

Further, interaction management engine 625 can determine whether a continuous channel between two devices (e.g. for a conversation or repeated transmissions between a user device and a system) should be established, used or terminated. A continuous channel can be structured so as to facilitate routing of future communications from a network device to a specified endpoint. This bias can persist even across message series (e.g., days, weeks or months). In some embodiments, a representation of a continuous channel (e.g., identifying an agent) can be included in a presentation to be presented on a network device. In this manner, a user can understand that communications are to be consistently routed so as to promote efficiency.

In one instance, a score can be generated using one or more factors described herein and a rule (e.g., that includes a weight for each of the one or more factors) to determine a connection score corresponding to a given network device and endpoint. The score may pertain to an overall match or one specific to a given communication or communication series. Thus, for example, the score may reflect a degree to which a given endpoint is predicted to be suited to respond to a network-device communication. In some embodiments, a score analysis can be used to identify each of an endpoint to route a given communication to and whether to establish, use or terminate a connection. When a score analysis is used to both address a routing decision and a channel decision, a score relevant to each decision may be determined in a same, similar or different manner.

Thus, for example, it will be appreciated that different factors may be considered depending on whether the score is to predict a strength of a long-term match versus one to respond to a particular message query. For example, in the former instance, considerations of overall schedules and time zones may be important, while in the latter instance, immediate availability may be more highly weighted. A score can be determined for a single network-device/terminal-device combination, or multiple scores can be determined, each characterizing a match between a given network device and a different endpoint.

To illustrate, a set of three endpoints associated with a client may be evaluated for potential communication routing. A score may be generated for each that pertains to a match for the particular communication. Each of the first two endpoints may have previously communicated with a network device having transmitted the communication. An input from the network device may have indicated satisfaction with an interaction with the communication(s) with the first device. Thus, a past-interact sub-score (as calculated according to a rule) for the first, second and third devices may be 10, 5, and 0, respectively. (Negative satisfaction inputs may result in negative sub-scores.) It may be determined that only the third endpoint is immediately available. It may be predicted that the second endpoint will be available for responding within 15 minutes, but that the first endpoint will not be available for responding until the next day. Thus, a fast-response sub-score for the first, second and third devices may be 1, 3 and 10. Finally, it may estimate a degree to which an agent (associated with the endpoint) is knowledgeable about a topic in the communication. It may be determined that an agent associated with the third endpoint is more knowledgeable than those associated with the other two devices, resulting in sub-scores of 3, 4 and 9. In this example, the rule does not include weighting or normalization parameters (though, in other instances, a rule may), resulting in scores of 14, 11 and 19. Thus, the rule may indicate that the message is to be routed to a device with the highest score, that being the third endpoint. If routing to a particular endpoint is unsuccessful, the message can be routed to a device with the next-highest score, and so on.

A score may be compared to one or more absolute or relative thresholds. For example, scores for a set of endpoints can be compared to each other to identify a high score to select an endpoint to which a communication can be routed. As another example, a score (e.g., a high score) can be compared to one or more absolute thresholds to determine whether to establish a continuous channel with an endpoint. An overall threshold for establishing a continuous channel may (but need not) be higher than a threshold for consistently routing communications in a given series of messages. This difference between the overall threshold and threshold for determining whether to consistently route communication may be because a strong match is important in the continuous-channel context given the extended utility of the channel. In some embodiments, an overall threshold for using a continuous channel may (but need not) be lower than a threshold for establishing a continuous channel and/or for consistently routing communications in a given series of messages.

Interaction management engine 625 can interact with an account engine 630 in various contexts. For example, account engine 630 may look up an identifier of a network device or endpoint in an account data store 635 to identify an account corresponding to the device. Further, account engine 630 can maintain data about previous communication exchanges (e.g., times, involved other device(s), channel type, resolution stage, topic(s) and/or associated client identifier), communication channels (e.g., indicating—for each of one or more clients-whether any channels exist, an endpoint associated with each channel, an establishment time, a usage frequency, a date of last use, any channel constraints and/or supported types of communication), user or agent preferences or constraints (e.g., related to terminal-device selection, response latency, terminal-device consistency, agent expertise, and/or communication-type preference or constraint), and/or user or agent characteristics (e.g., age, language(s) spoken or preferred, geographical location, interests, and so on).

Further, interaction management engine 625 can alert account engine 630 of various connection-channel actions, such that account data store 635 can be updated to reflect the current channel data. For example, upon establishing a channel, interaction management engine 625 can notify account engine 630 of the establishment and identify one or more of: a network device, an endpoint, an account and a client. Account engine 630 can subsequently notify a user of the channel's existence such that the user can be aware of the agent consistency being availed.

Interaction management engine 625 can further interact with a client mapping engine 640, which can map a communication to one or more clients (and/or associated brands). In some embodiments, a communication received from a network device itself includes an identifier corresponding to a client (e.g., an identifier of a client, product, service, webpage, or app page). The identifier can be included as part of a message (e.g., which client mapping engine 640 may detect) or included as other data in a message-inclusive communication. Client mapping engine 640 may then look up the identifier in a client data store 645 to retrieve additional data about the client and/or an identifier of the client.

In some embodiments, a message may not particularly correspond to any client. For example, a message may include a general query. Client mapping engine 640 may, for example, perform a semantic analysis on the message, identify one or more keywords and identify one or more clients associated with the keyword(s). In some embodiments, a single client is identified. In some embodiments, multiple clients are identified. An identification of each client may then be presented via a network device such that a user can select a client to communicate with (e.g., via an associated endpoint).

Client data store 645 can include identifications of one or more endpoints (and/or agents) associated with the client. A terminal routing engine 650 can retrieve or collect data pertaining to each of one, more or all such endpoints (and/or agents) so as to influence routing determinations. For example, terminal routing engine 650 may maintain an endpoint data store 655, which can store information such as endpoints' device types, operating system, communication-type capabilities, installed applications accessories, geographic location and/or identifiers (e.g., IP addresses). Information can also include agent information, such as experience level, position, skill level, knowledge bases (e.g., topics that the agent is knowledgeable about and/or a level of knowledge for various topics), personality metrics, working hours, language(s) spoken and/or demographic information. Some information can be dynamically updated. For example, information indicating whether an endpoint is available may be dynamically updated based on (for example) a communication from an endpoint (e.g., identifying whether the device is asleep, being turned off/on, idle/active, or identifying whether input has been received within a time period); a communication routing (e.g., indicative of whether an endpoint is involved in or being assigned to be part of a communication exchange); or a communication from a network device or endpoint indicating that a communication exchange has ended or begun.

In various contexts, being engaged in one or more communication exchanges does not necessarily indicate that an endpoint is not available to engage in another communication exchange. Various factors, such as communication types (e.g., text, message, email, chat, phone), client-identified or user-identified target response times, and/or system loads (e.g., generally or with respect to a user) may influence how many exchanges an endpoint may be involved in.

When interaction management engine 625 has identified an endpoint to involve in a communication exchange or connection, it can notify terminal routing engine 650, which may retrieve any pertinent data about the endpoint from endpoint data store 655, such as a destination (e.g., IP) address, device type, protocol, etc. Processing engine 610 can then modify the message-inclusive communication or generate a new communication (including the message) so as to have a particular format, comply with a particular protocol, and so on. In some embodiments, a new or modified message may include additional data, such as account data corresponding to a network device, a message chronicle, and/or client data.

A message transmitter interface 660 can then transmit the communication to the endpoint. The transmission may include, for example, a wired or wireless transmission to a device housed in a separate housing. The endpoint can include an endpoint in a same or different network (e.g., local-area network) as connection management system 150. Accordingly, transmitting the communication to the endpoint can include transmitting the communication to an inter- or intra-network connection component.

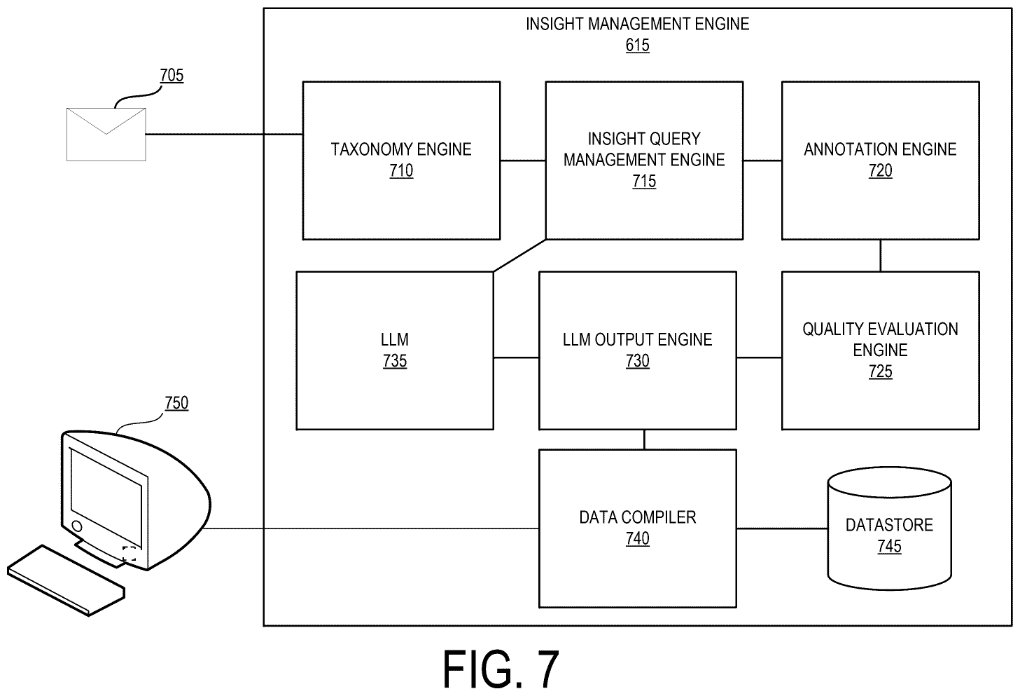

FIG. 7 shows an example embodiment of an insight management engine 615 in accordance with some aspects of the present technology. The insight management engine 615 may receive a communication 705 or access such a communication from a message data store 620. The communication 705 may be processed by a taxonomy engine 710, an insight query management engine 715, an annotation engine 720, a quality evaluation engine 725, a Large Language Model (LLM) output engine 730, an LLM 735, and an insight data compiler 740. The resulting compiled data may be provided to an interface of a computing device 750, such as a network device, a client device, and/or a terminal device for analysis and/or manipulation, as described further herein.

Communication 705 may be provided to a taxonomy engine 710. Communication 705 may be in natural language as described herein and may include one or more words. In some embodiments, communication 705 can include words in different languages, words embodied as pictograms or emoticons, or strings of characters. In some examples, words can be received in communication 705 as audio data, and converted to text using voice-to-text systems of the taxonomy engine 710. If communication 705 is part of a conversation received via the message receiver interface 605, the taxonomy engine 710 and/or the insight query management engine 715 may manage storage of the communication 705 in the message data store 620.

If the communication 705 is an analysis query received via the insight I/O 616, the communication 705 can be processed and used in generating a summary of sampled data from the message data store 620. The taxonomy engine 710 may be configured to, in conjunction with a processor, parse the communication 705 to identify one or more key words, also referred to herein as “operative words”. The taxonomy engine 710 may, for example, receive a query input from the insight management I/O 616 “summarize recent feedback on product X”, with “feedback” and “product X” identified as operative words. In some aspects, the operative words can be matched with metadata to limited data from the message data store 620 to be sampled.

In other aspects, metadata is not used in filtering, and a LLM can be used to manage data analysis, including handling of sampled data not related to feedback or product X when generating a data summary.

In either instance, the insight query management engine 715 samples relevant data from the message data store 620, and then provides the sampled data along with the query to a large language model 735. The large language model accepts the query and the sampled communication data, and generates a LLM output at LLM output engine 730. In some aspects, a quality evaluation engine 725 can perform analysis on the LLM output to confirm that the output meets certain criteria. If issues arise with the output, the annotation engine 720 can modify or add notes to the LLM output. For example, expletives or other information may be modified or removed by the quality evaluation engine 725, and the annotation engine 720 may provide notes in the LLM output text associated with such modifications. In some aspects, rails associated with particular categories, such as personal customer identifying information, demographic information, or other such information can be checked and/or modified by the quality evaluation engine 725 and the annotation engine 720.

In some aspects, the quality evaluation engine 725 can include a machine learning model separate from the LLM 735 and used to characterize outputs of the LLM 735 provided to the LLM output engine 730. Feedback data with annotation training, examples of unmodified LLM output data matched with preferred matching LLM output data, and other such training data can be provided to the quality evaluation engine to periodically train the quality evaluation engine 725 on historical LLM output data matched with preferred modified or flagged data. In one example, based on an identified insight category, an insight query management engine 715 selects an LLM 735 based on an identified insight category. This particular LLM 735 can be selected from multiple different AI engine options. For example, different insight categories or groups of categories can be associated with different AI engines, including the system for the LLM 735. For example, in a training mode, test queries can be provided to the taxonomy engine 710, and each LLM output associated with an acceptable or unacceptable response flag. The provided flags can be used by the quality evaluation engine 725 to train learning systems. Examples of preferred modifications or notes matched with the unacceptable flags can be provided to learning systems of the annotation engine 720 to train automated annotations.

Such feedback can be implemented in machine learning models used by the quality evaluation engine 725 and the annotation engine 715 to monitor system performance. The data compiler 740 can format the output data from the LLM output data into a format for insight management I/O to be provided on a user interface, and to be stored in a datastore 745 (e.g., for use as training data or to track system use make queries and associated summaries generated by a system reviewable.)

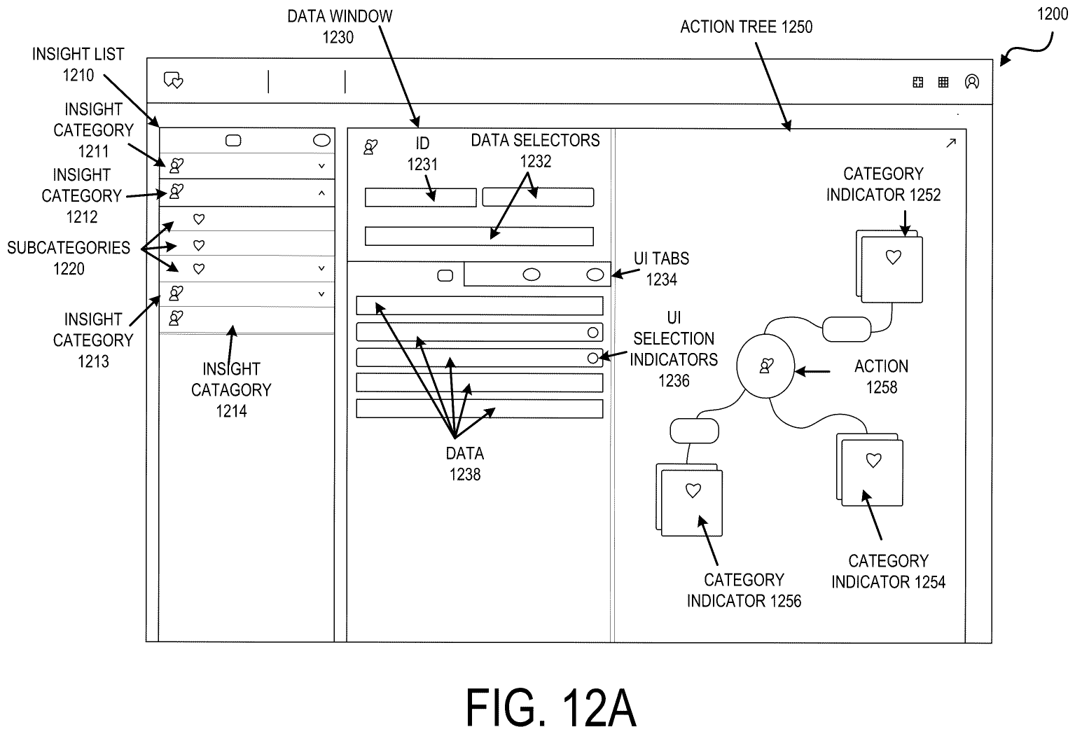

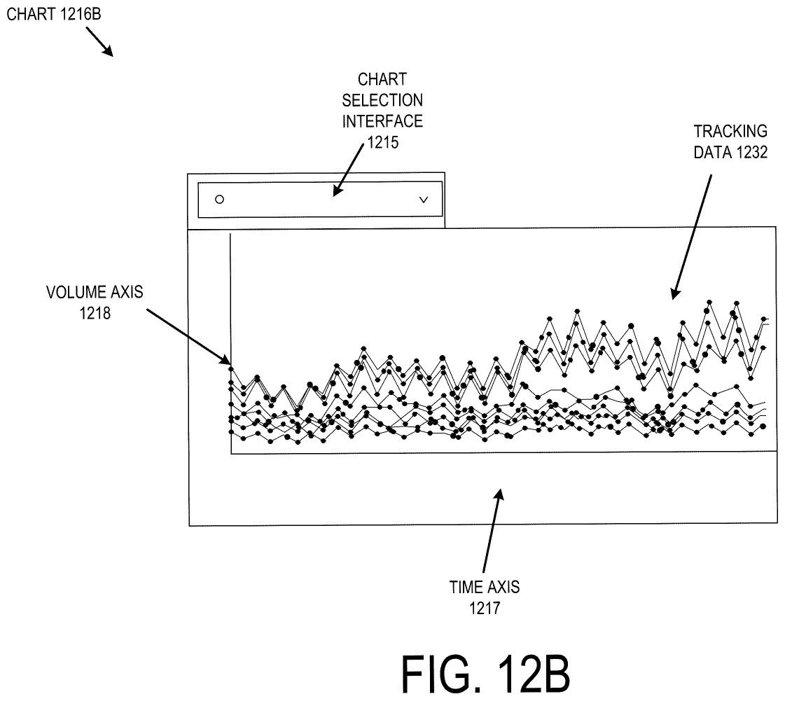

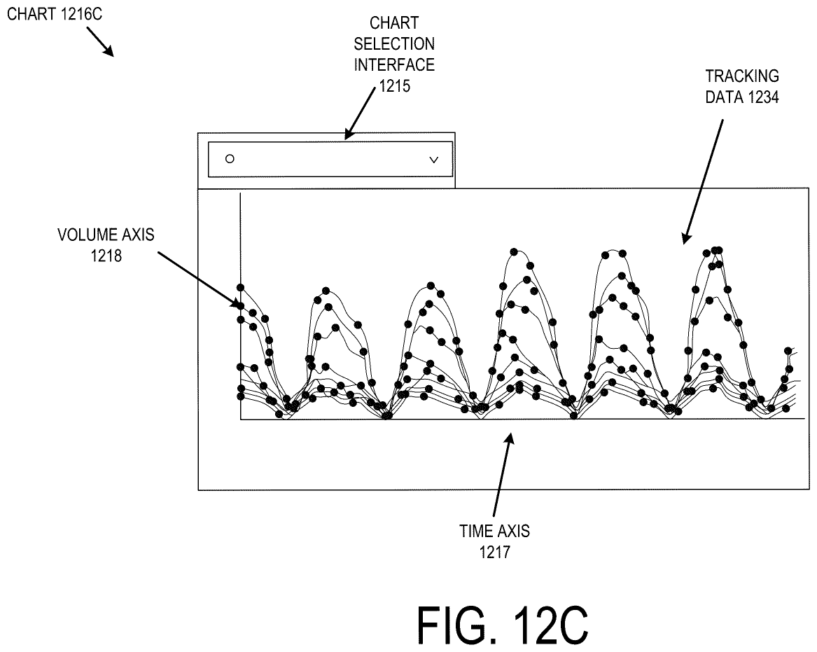

The insight data compiler 740 is configured to, in conjunction with a processor, aggregate the information output by the LLM 735 and formulate it in such a way that can be displayed by the computing device 750. The computing device 750 is able to manipulate and configure the data displayed and analyzed. In some aspects, this includes user selectable options, such as text font style, size, page formatting, etc. In other aspects, this can include additional data formatting for the interfaces of FIGS. 12A-C.

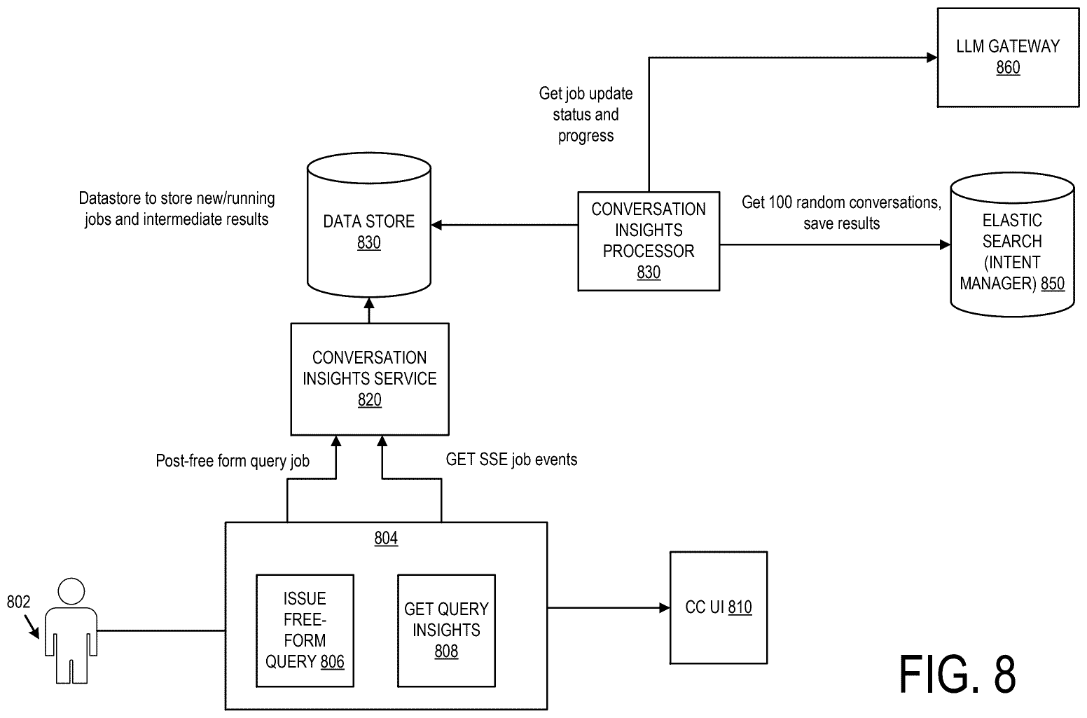

FIG. 8 shows a flow 800 of processes and systems used for generating a summary of communications in accordance with aspects described herein. FIG. 8 may be considered an alternate implementation or an alternative perspective on the insight management engine 615 of FIG. 7. In the flow 800 of FIG. 8, a user 802 accesses a computing device 804 to provide a query 806 and receive a query response 808 via a user interface 810. As indicated above, method embodiment in accordance with some aspects of the present technology. The described method describes an embodiment of analyzing an insight. In some examples, the method described by the flow 800 is performed by a computing device. An insight service 820 processes the initial query, to initiate datastore 830 sampling. The datastore 830 can be used to store query data, output data, and intermediate results (e.g., intermediate summaries) when final summary data is generated from a summary of summaries, as detailed further below. The conversation insights processor 840 manages summary processes, including managing LLM access, data storage access to database 850 (e.g., which can be similar to the message data store 620), and other such operations of a system as detailed further below (e.g., LLM scheduling, intermediate application programming interface formatting for LLM communications, etc.) As described in FIG. 8, an LLM gateway 860 is used to provide query data and receive query results from an AI/LLM system. In some such aspects, a remote and/or third party LLM system can be used as part of the flow 800. In other aspects, a local LLM can be integrated with a system, or included as part of the conversation insights processor 840.

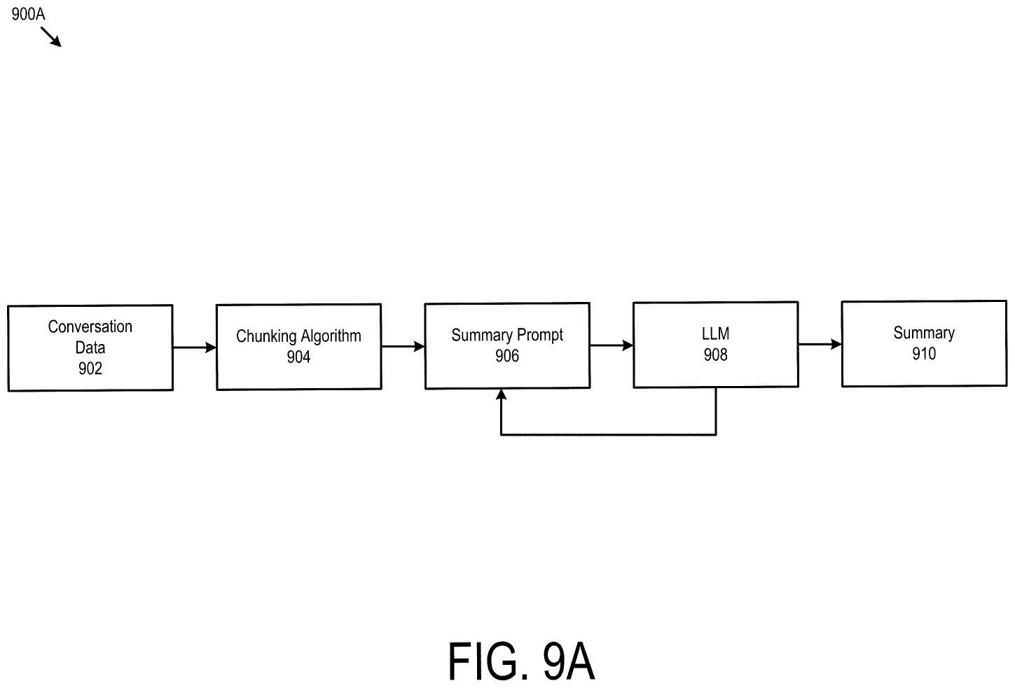

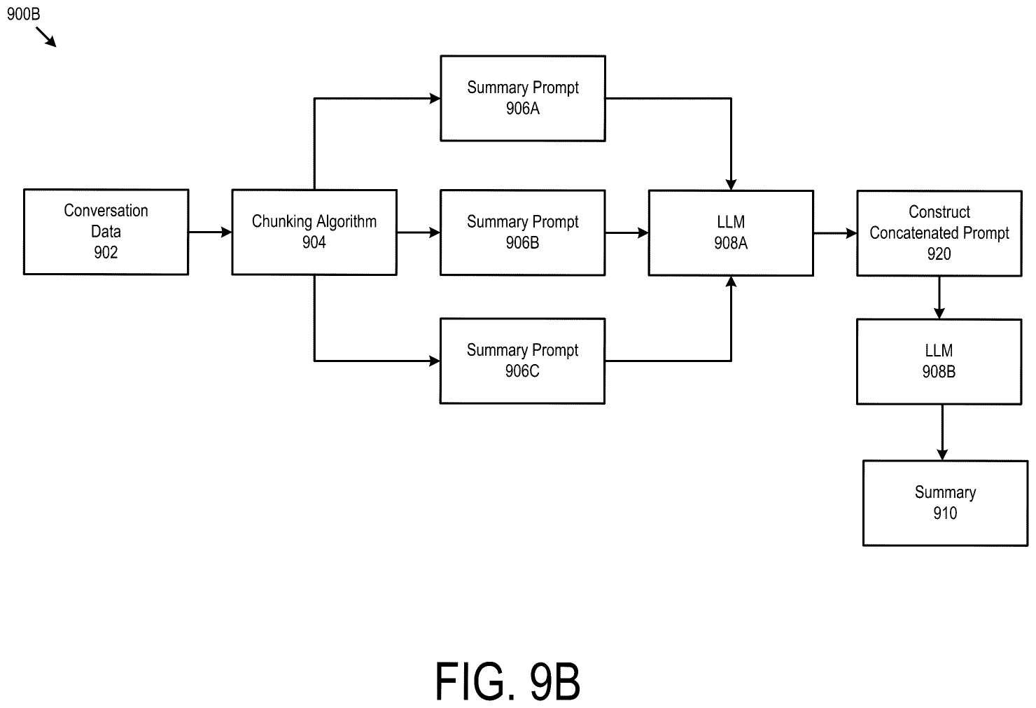

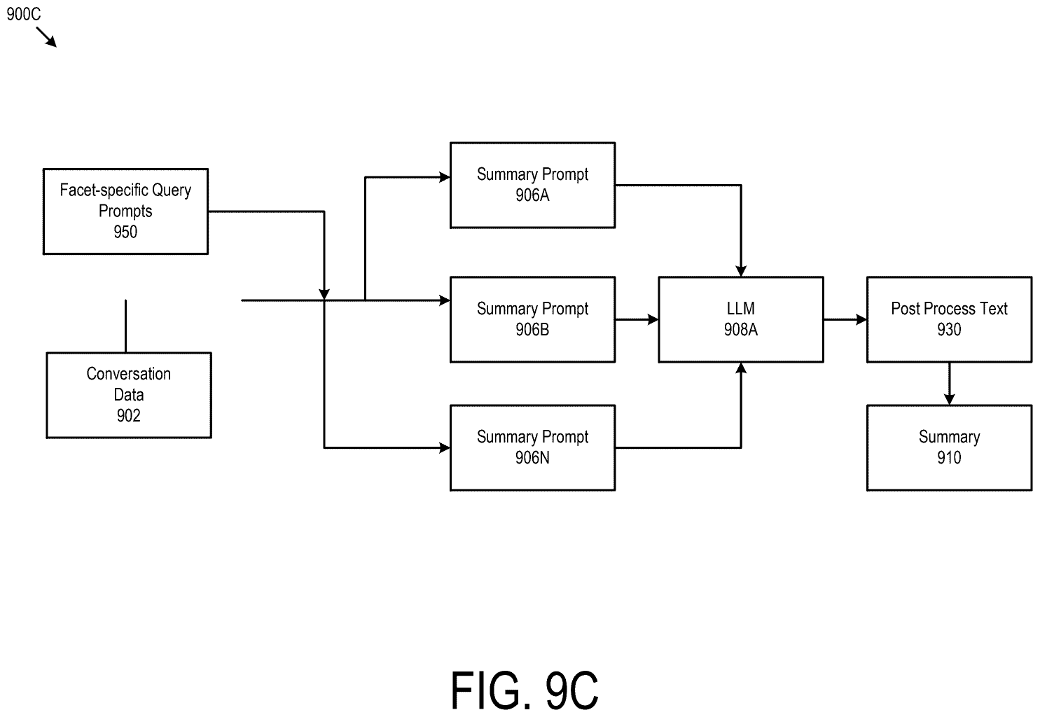

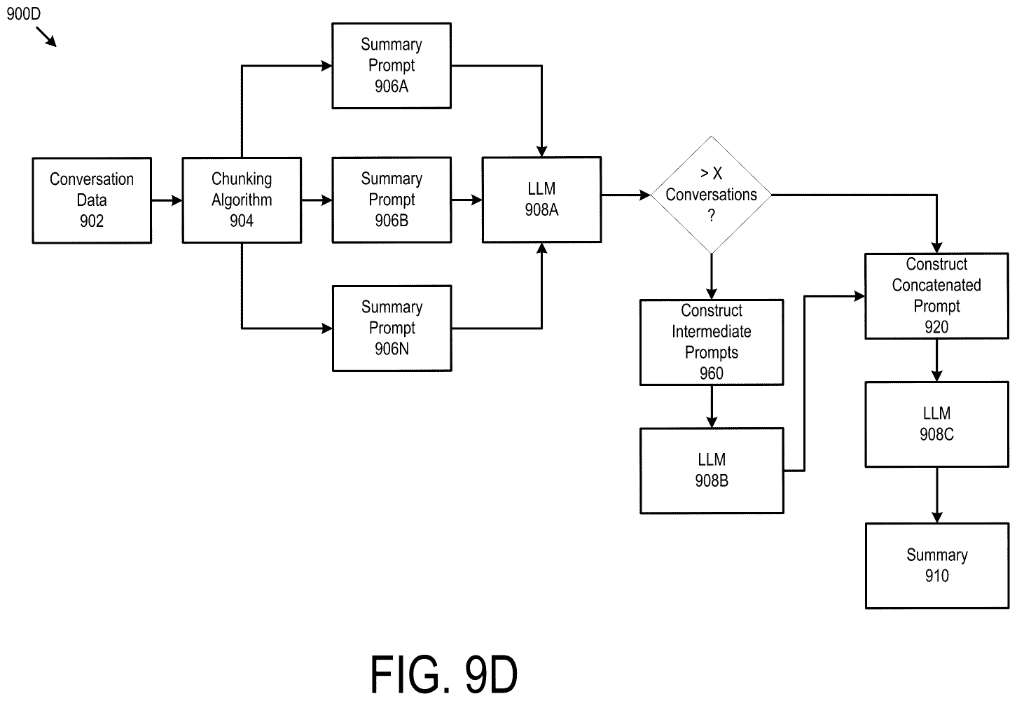

FIGS. 9A-D, 10A-B, and 11 illustrate example methods that can be implemented using systems described herein, such as the systems of FIG. 7 and FIG. 8, or any other such systems described or apparent from the descriptions provided herein.

FIG. 9A shows a flowchart 900A of a method embodiment in accordance with some aspects of the present technology. In FIG. 9A, the flowchart 900A describes a method that can be implemented with limited learning or training using LLMs. In some aspects of methods for summarizing described herein, a limit on query length can be implemented, and conversation data can be limited to a threshold character limit (e.g., 10,000 characters, 12,000 characters, 20,000 characters, etc.). Such conversations can be made up of any number of messages. In some aspects, the character limit for conversations can be set by trimming conversations that are of the character limit, using a trimming algorithm. Such an algorithm can remove information lite characters (e.g., introductions, sign-off boilerplate, etc.), and then remove all characters of the limit, either at an end, a beginning, or using another prioritized trimming operation for a conversation. The number of sampled conversations can similarly be limited to a threshold number in some aspects.

Summarizing operations such as those described herein can be particularly well suited to limited learning (e.g., zero-shot learning). Some learning can be used to guide the model towards a particular summary style (e.g., few-shot learning), but such guidance can be difficult to implement when summarization in LLMs is applied to longer conversation lengths.

In some aspects, different methods can be used on different conversations, depending on the length of a conversation, with no conversation trimming applied. For conversations below a given character threshold (e.g., fewer than approximately 12,000 characters), an instruction prompt (e.g., a query) and a conversation prompt (e.g., the conversation data) can be concatenated to make a single request to an LLM for summary generation of the provided conversation. For longer conversations, chunking and chaining operations can be used, as described below. The flowchart 900A describes an example chunking and chaining method.

In block 902 of the flowchart 900A, conversation data is received (e.g., by a conversation insights service 820 or an insight query management engine 715). In block 904 of the flowchart 900A, a chunking algorithm is applied to the conversation data (e.g., due to the conversation data being over a character threshold). In block 906 of the flowchart 900A, the summary prompt (e.g., query) or a specialized summary prompt for a given chunk of data generated by the chunking algorithm is generated and provided to a LLM. In block 908 of the flowchart 900A, an LLM generates intermediate summary data which is used to modify the summary prompt of the block 906. A loop of LLM summarization in the block 908 and summary prompt generation (e.g., updates or modification with feedback from the LLM) proceeds for each chunk generated by the chunking algorithm in the block 904. Once the summary prompt and LLM summary loop is completed for all conversation chunks, the final output of the LLM from the block 908 generates an output summary in the block 910.

Such a chaining method may result in a high latency if a large number of sampled conversations are processed serially, and if simultaneous queries are accepted by a system. In some aspects, when a third part LLM service is used (e.g., via an LLM gateway such as the LLM gateway 860 described above), throughput limits may be implemented by the LLM service, which can further increase latency if large conversations, large conversation sample sizes, or simultaneous query processing is supported by a system. In some aspects, such latency can be managed by parallel processing, increasing LLM throughput support, or by batching, combining, and/or scheduling operations. In some aspects, summary combining may reduce quality, and parallel processing (e.g., of conversation chunks) can remove context from summary operations that reduces the quality of a final summary, reducing summary quality for an increase in system speed and throughput.

FIG. 9B shows a flowchart 900B of a method embodiment in accordance with some aspects of the present technology. FIG. 9B shows an implementation with parallel construction and analysis of conversation chunks. As mentioned in the serial flowchart 900A above, blocks 906 and 908 can repeat for serial processing of conversation chunks, which can reduce response time, but improve performance where the LLM has information about prior chunks in the serial processing.

In the blocks of the flowchart 900B, the conversation data of block 902 and chunking algorithm of block 904 proceed the same as in the flowchart 900A, but in the flowchart 900B, summary prompts in blocks 906A, 906B, and 906C are generated in parallel and provided to the block 908A LLM processing in parallel as LLM resources are available. The parallel chunk summaries are concatenated in block 920, rather than a summary being generated in a step-wise fashion at each serial iteration as described in the flowchart 900A. In the flowchart 900A, after the concatenated prompt operation of the block 920, the LLM from block 908A, or a different LLM, is used in block 908B to process the concatenated prompt generated from the LLM in block 908A (e.g., using the summaries from the chunks generated by the LLM in the block 908A). The LLM in block 908B then outputs the final summary for the conversation in block 910.

In some aspects, a conversation may be too large to generate an effective summary, for example, if too many chunks are present for an effective constructed concatenated prompt in the block 920. In some aspects, an implementation may have a chunk summary limit, (e.g., no more than N repetitions in the flowchart 900A, or no more than N chunks in the flowchart 900B.) In some aspects, information density in messages of a conversation may be used to limit conversation size as described above, or a threshold number of characters from the end of the conversation may be used (e.g., where key information on the disposition of the conversation is expected to be present).

In either of the examples above, because limited learning is present for the LLM summary outputs, prompts or user selection criteria can be used to set a summary style, by requesting a characteristic (e.g., “simple,” “translated to language X,” in “context X,” etc.) In other aspects, style training can be used (e.g., with an annotation engine 720 or a quality evaluation engine 725).

In any of the flowcharts described herein, a summary prompt, such as “summarize recent communications for merchant X” can be used. Recent communications can be sampled if more than a threshold number exist, and each conversation processed to generate a conversation summary in accordance with the flowchart 900A or the flowchart 900B.

FIG. 9C shows a flowchart 900C of a method embodiment in accordance with some aspects of the present technology. The flowchart 900C describes a structured summary generation process that provides a more detailed and focused summary in accordance with some aspects. For example, the detailed summary generated by the flowchart 900C method can contain a conversation topic, a customer sentiment analysis, and a list of products or services discussed. For each facet of the conversation (e.g., topic, product or service, sentiment, intent, etc.), a separate request can be made to an LLM, with separate prompts generated by the insight system from an initial free-form query. The constructed prompts can consist of generic instructions, the conversation data (e.g., formatted as conversation prompt data for an LLM API, and facet-specific queries. The response outputs can be output formatted and concatenated to produce a single summary response with the facet specific details. In some aspects, such facets are customizable for customer or merchant data (e.g., identifying products and services associated with a customer or merchant). In some such aspects, facets can be selected or configured via a graphic user interface, with a user-friendly display, and facet description. In other aspects, text inputs associated with facets can be used.

In the flowchart 900C, the blocks begin with a user input. As indicated above, the input can be a free language query, or can include selected facets (e.g., topic, product or service, sentiment, intent, etc. selected via text query or a graphic interface). When this information is received, the flowchart generates N facet-specific query prompts for each selected facet in block 950, and formats the conversation data in block 902 the same as flowcharts 900A and 900B. The conversation data is then processed in parallel in blocks 906A-N. In another aspect, such prompts can be processed serially rather than in parallel using an LLM from the block 908. In block 930, post processing is applied to the separate LLM outputs from block 908 to merge the summaries for each facet-specific query prompt. In some aspects, this can be a concatenated set of summaries submitted to the same LLM or a different LLM as described for the flowchart 900B. In other aspects, a facet specific integration format or LLM summary system for facet specific selections can be used, and a final detailed summary with facet specific information is provided in the final summary for the conversation of the block 910.

For such conversation summaries, a threshold number of facets may be set as a limit (e.g., 10 facets) for a single conversation summary, to allow acceptable summary quality and LLM throughput availability. When the conversation being summarized exceeds a character limit (e.g., as in the flowchart 900B), each facet can be subject to chunking summaries, such that N×M LLM summaries are performed, where N is the number of chunks a conversation is broken into based on a character limit, and M is the number of facets in a query. Such LLM summaries can be processed in any fashion serially or in parallel, with the chunks subject to post processing to integrate the separate summaries as described above. For example, separate chunk summaries can be merged for each facet, and then the facets can be merged in a final summary.

In some aspects, it is possible for different facets to provide different and conflicting summaries. In some such aspects, post processing, or a quality evaluation system (e.g., the quality evaluation engine 725) can be used to check for such conflicts.

In some aspects, such conflicts can be identified, and the summary resolutions generated or identified in response to the conflicts, used as training data for a quality evaluation system or for post-processing systems that generate a final summary. For example, in some aspects, a particular merchant may be associated with multiple conversations where an initial issue (e.g., facet) is identified from a pattern present in initial parts of a conversation, but a second issue (e.g., facet) is then identified as the correct facet. Such patterns can be identified on a merchant or customer bases, and used to train quality or post-processing results from LLM summaries in accordance with aspects described herein.

TABLE 1

| Prompt type | Text |
|---|---|
| Query Instruction | Given a conversation between a customer and |
| | support agent, answer the question as |
| | precisely as possible and explain your |
| | reasoning for the answer. If the answer isn't a |
| | simple yes or no, provide an explanation |
| | about why the answer is nuanced. |
| Conversation prompt | text: |
| with query | “”” |
| | Customer: Hi |
| | Agent: Hello |
| | “”” |
| | Question: {user_query} |
| | Answer: |
| Sample Display String | Customer Request(s) |
| Sample Query String | In a few words, what was the customer's |
| | request? |

Table 1 provides a template for example data processed in accordance with the flowcharts described herein. For example, a freeform query can be associated with the standard query instructions in table 1. The conversation prompt with query can then accept a free-form text query via a text interface. The query can ask for general or facet specific conversation summaries, and the system can generate summary text in response to the user query for a sampled conversation.

FIG. 9D shows a flowchart 900D of a method embodiment in accordance with some aspects of the present technology. FIGS. 9A-C described flowcharts for summaries of individual conversations, with chunking and facet based segmentation for summary generation. FIG. 9D then describes how summaries of multiple conversations can be summarized to generate an LLM based summary of sets of conversations. In the flowchart 900D, conversation data in block 902 includes data for multiple conversations. As described above, summary operations using an LLM can have difficulty directly generating summaries for too much information. In the flowchart 900D, if more than X conversations are to be summarized, intermediate summaries of subsets of conversations can be generated, and then a summary of the intermediate summaries can be used to generate the final summary.

Regardless of how many conversations are included in the block 902, in the block 904, a chunking algorithm can be used for conversations having greater than a threshold number of characters. If less than a threshold number of characters is present, a single summary prompt 906C can be generated for the conversation in a block 906A, with a single summary generated in block 908A by an LLM. If more characters are present, chunk summaries can be generated and used to created a final conversation summary as described in flowcharts 900A and 900B. If fewer than X conversations are present in the conversation data at block 902, then the flowchart 900D proceeds to block 920, where the summaries for each conversation are concatenated into a summary prompt for block 908C, where an LLM (e.g., either the LLM from the block 908A or a separate LLM) generates a final summary from the prompt in block 920 generated from the summaries of each conversation. If more than a threshold X number of conversations are present, then intermediate summaries of subsets of conversations can be generated, using intermediate constructed prompts in block 960 generated from groups of the conversation summaries generated in block 908A. These intermediate prompts generated from the groups of conversation summaries can be provided to an LLM in block 908A to generate summaries of the group summaries. In other words, block 908A outputs summaries for each individual conversation. Block 960 groups the conversation summaries from the block 908A into multiple groups, and each of the multiple groups has an intermediate summary generated by an LLM in block 908B. These multiple summaries from the block 908B can then be provided to block 920 for generation of a final single constructed concatenated prompt. The block 908C generates a final single summary output at the block 910.

Thus, as described in the flowchart 900D, any number of conversations of any length can be processed by LLM analysis that has a limited ability to summarize information, by segmenting the data in various ways to generate intermediate summaries. These intermediate summaries can be generated at the conversation chunk level, the conversation facet level, a level for groups of conversations, and a final summary level. Some or all of these levels can be used for intermediate summaries in different aspects, with the intermediate summaries used to generate additional summaries, which can further be summarized depending on the system organization and query provided to the system. In some such systems, the input can be structured or segmented into a conversation query to generate conversation summaries, and a summary query to generate the final summary. In some aspects, LLM concurrency limits can be used in selecting chunking or summary groupings. The intermediate constructed prompts or the concatenated prompts of the blocks 920 and/or 960 can be generated using the summary query, which can either be provided directly in the initial query, or generated by a system from the initial query.

In some aspects, wording of an initial query provided to a system can impact result quality. In some such aspects, a quality or annotation system can be used to modify or alter query inputs into queries known to generate preferred results. For example, in some aspects, summary queries may provide improved results when focused on multiple use cases (e.g., (using enumerated, bullet point lists, or prose summaries of the conversation query answers). In some aspects, summary queries can be constrained for users to a limited set of summary queries. In such aspects, the summary queries can be selectable via a graphical user interface, or can be selected in response to a closest match with freeform text provided as a query, as determined by the system. In some aspects, machine learning input query systems (e.g., the taxonomy engine 710) can be used with machine learning feedback to match preferred results with LLM API inputs to translate freeform text into LLM API inputs known to generate preferred results.

In some aspects, numeric queries provided to a system (e.g., how many customers did Y, or what percentage of customers did Z?) can produce widely varying results depending on the LLM. In some aspects, a taxonomy engine or management engine can select particular LLM systems known to handle such numerical queries. For example, such queries may be handled differently than summary queries, with summary queries using the aspects described above, and numerical queries analyzing each conversation, rather than sampled conversations, using an efficient analysis to determine whether the conversation matches the numeric criteria in the query.

In some aspects, summary outputs from LLMs do not have direct links available to specific conversations. In some aspects, numeric conversation analysis can be combined with LLM text summary outputs to provide links or other interfaces to review the sampled conversation data used to generate the summary. For example, in some aspects, a URL, conversation identification number, or other identifying information can be provided with a summary output to allow review of both the LLM generated summary and the conversation data used to generate the LLM generated summary.

TABLE 2

| Prompt type | Text |
|---|---|
| Conversation Query | Given a conversation between a customer and |
| Header | support agent, answer the question as |
| | precisely as possible and explain your |
| | reasoning for the answer. If the answer isn't a |
| | simple yes or no, provide an explanation |
| | about why the answer is nuanced. |
| Conversation prompt | text: |
| with query | “”” |
| | Customer: Hi |
| | Agent: Hello |
| | “”” |
| | Question: {user_query} |
| | Answer: |
| Intermediate | Summarize the responses in the text. If |
| Summarization Header | products are mentioned, include product |
| | details in the response. |
| Final Summary Query | Given the text responses about different |
| Header | customer support conversations, answer the |
| | question as precisely as possible and explain |
| | your reasoning for the answer. |
| Sample conversation | Is the customer frustrated in this |
| query | conversation? |
| Sample aggregation | List the top 5 reasons customers are frustrated. |
| query | |

Similar to table 1, table 2 provides example formats for a summary of summaries operation as described with respect to the flowchart 900D. A conversation query, an intermediate summarization header, and a final summarization header can be provided as part of a query, or generated by a taxonomy or management engine from a free form conversation or aggregation query provided to a system.

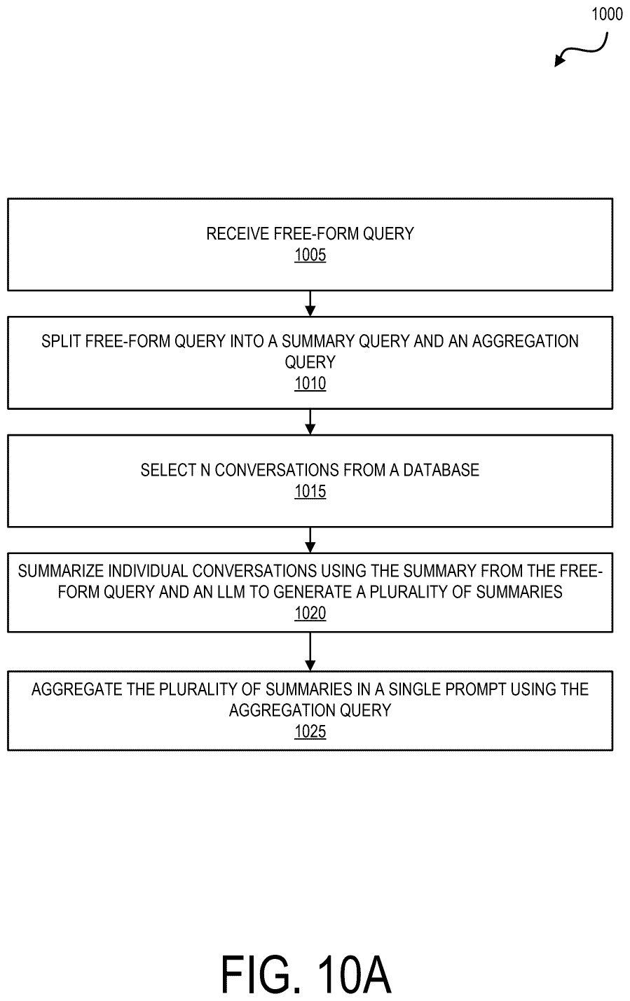

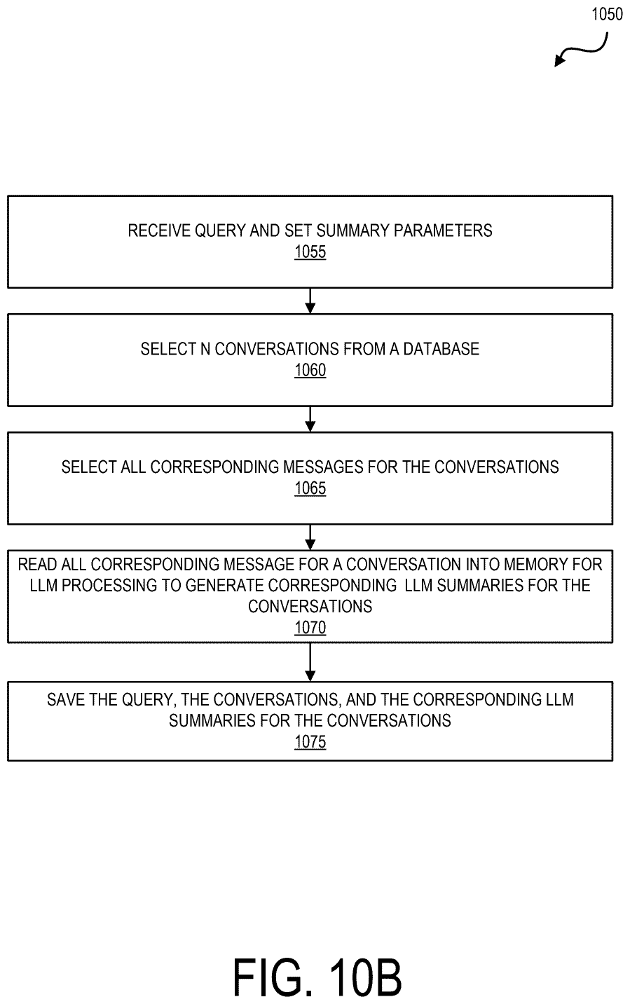

FIG. 10A shows a flowchart 1000 of a method embodiment in accordance with some aspects of the present technology. Just as for FIGS. 9A-D, the flowchart 1000 of FIG. 10A can be implemented by the systems of FIG. 7, 8, or any such system described herein. In some aspects, a conversation insight processor application can be used to manage operations as described herein. In some such aspects, an external user interface browser (e.g., the UI 810) can be used to receive queries. In other aspects, other interfaces can be used.

In the flowchart 1000, block 1005 involves receiving a free-form query (e.g., via the UI 810). The free-form query is then split into a summary query and an aggregation query in block 1010 (e.g., using the conversation insights service 820, the computing device 804, a browser, an application, the taxonomy engine 710, the insight query management engine 715, or any other such structure depending on the particular implementation). In block 1015, the managing system from the block 1010 samples conversations from a database (e.g., the message data store 620) depending on the particular query from the block 1005. In block 1020, individual conversations are summarized using the sampled conversations from the block 1015, and the summary query from the block 1020. In block 1025, the summaries generated in the block 1020 are aggregated with the aggregation query, and submitted to an LLM in a single prompt to generate a final summary. In some aspects where additional details or particular query types are present, different formatting or additional summarization (e.g., facet, statistics, etc.) can be performed in addition to or in conjunction with the operations described in the flowchart 1000.

FIG. 10B shows a flowchart 1050 of a method embodiment in accordance with some aspects of the present technology. The flowchart 1050 describes an alternative embodiment where summary parameters are selected, either as defaults, as system settings, or as part of a query. Such parameters can include parameters for numerical summaries, facet summaries, or any other such summary aspects in addition to the provided query (e.g., free-form text, GUI inputs, etc.)

In block 1055 of the flowchart 1050, the query is received and summary parameters are set, either by system settings, defaults, or inputs received with the query. In block 1060, conversations are selected from a database based on the query input and parameters from the block 1055. In the block 1065, the messages associated with the conversations identified in the block 1060 are selected, and in block 1070, the message text is read into memory for LLM processing to generate LLM summaries for each conversation from the corresponding messages of the conversation. In block 1075, the individual conversation summaries are stored with the query for use in additional summarizing operations using one or more LLMs.

In some such aspects, each summarizing operation is associated with an authenticated an authorized API request that can be managed by a management system (e.g., service 820, engine 715, etc.). Such management systems can monitor query input (e.g., start) times, summary completion (e.g., end) times, LLM loads, error or quality metrics (e.g., using the annotation engine 720, the quality evaluation engine 725, the conversations insight processors 840, etc.). In some aspects, many (e.g., tens, hundreds, thousands) of such summaries can be processed simultaneously, with different operations of different summary processes occurring in a system at the same time. In some aspects, rate limits can be implemented based on LLM accessed, particularly for third party LLMs access via an API gateway (e.g., the LLM gateway 860). In some aspects, a queueing system can be used to managed such rate limits. In other aspects, congestion or unavailable errors can be provided at a UI when rate limits are exceeded or queues are full.

In some aspects, for privacy, conversation data can be masked or otherwise processed to prevent identifying information to be included in a summary. In some such systems, conversation data stored in a message database is encrypted for security, and sampling or selection of conversation data can involve description along with masking personal information. In some aspects, messages stored in a database can be purged on a frequent basis, or access to data by a summary system can be limited to conversations in a particular time period (e.g., the past 7 days, the past month, etc.)

In some aspects, a special database of decrypted and masked data can be used (e.g., the database 850) from an encrypted database (e.g., the message data store 620) to improve summary latency, and to prevent repeated description operations for each query. Similarly, data generated as part of summary operations can be stored in a special secured storage (e.g., the datastore 745) for review along with masked data used to generate summaries, in order to prevent duplication of summary operations when duplicate or similar queries are performed within a threshold time period (e.g., within the same day, within a threshold number of hours, etc.) In some aspects, particularly when sampled conversations used to generate a summary is small compared to the number of candidate conversations, a query may specify whether to use alternative samples for a subsequent summary. In some aspects, sample sizes can be based on the conversation candidate pool size to obtain a representative number of samples, and to reduce the likelihood of a summary representing outliers. In such aspects, additional tiers of summaries can be used, with system quality checks used to discard outliers, or generate final summaries representative of the larger summary details rather than low frequency summary details.

In some aspects particular conversation details can be used as a facet. For example, abandoned conversations can be isolated from completed or resolved conversations, with separate summary operations for each, or explicit query inputs used for samples of both facets of conversation.

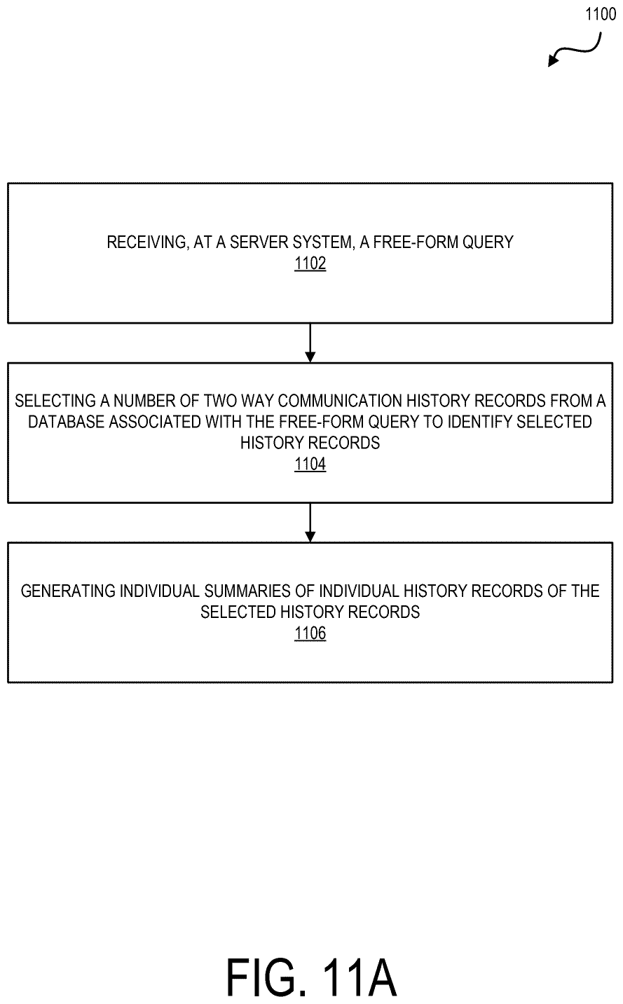

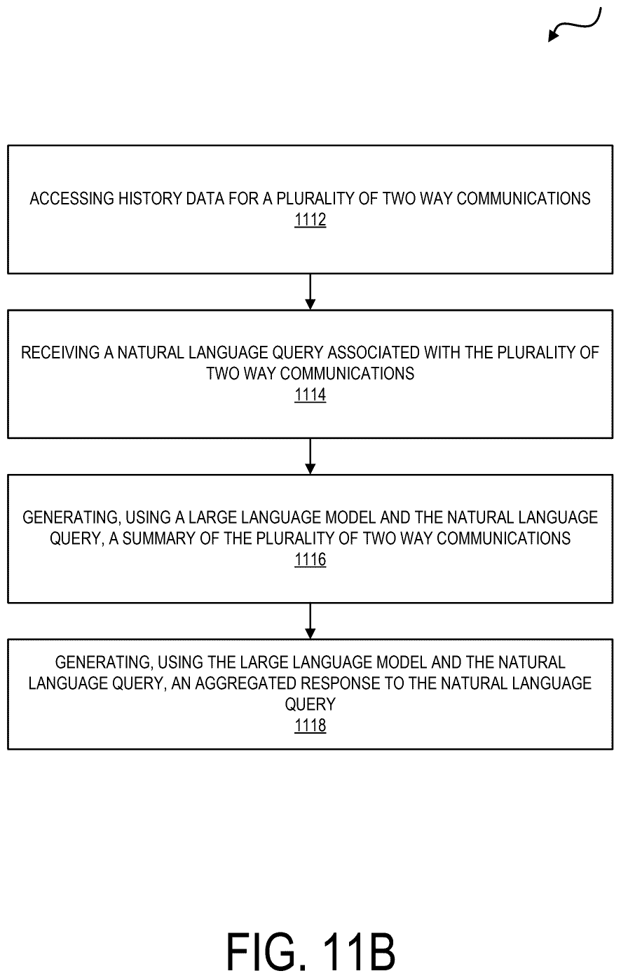

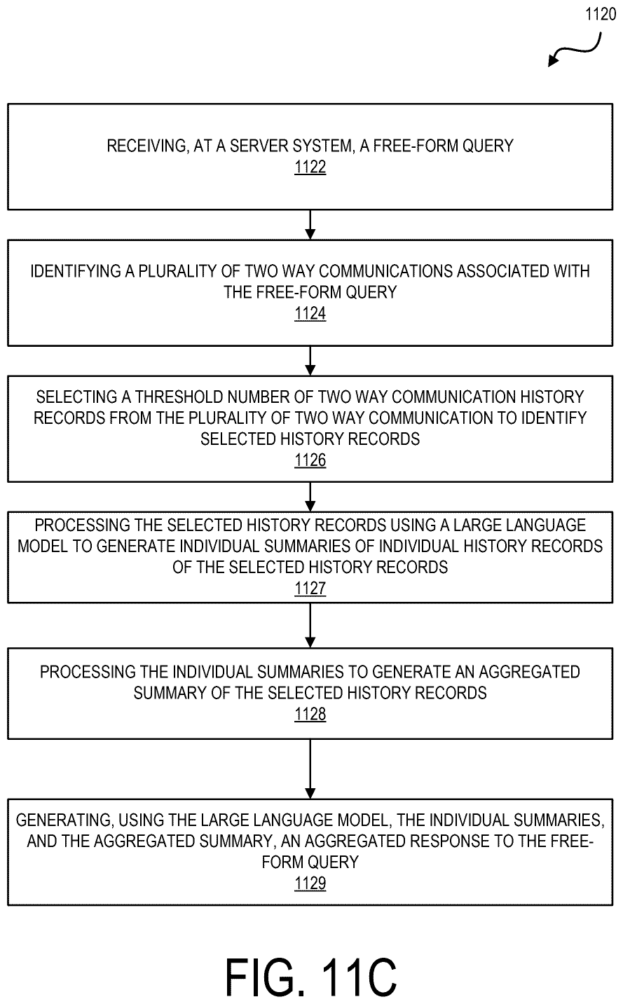

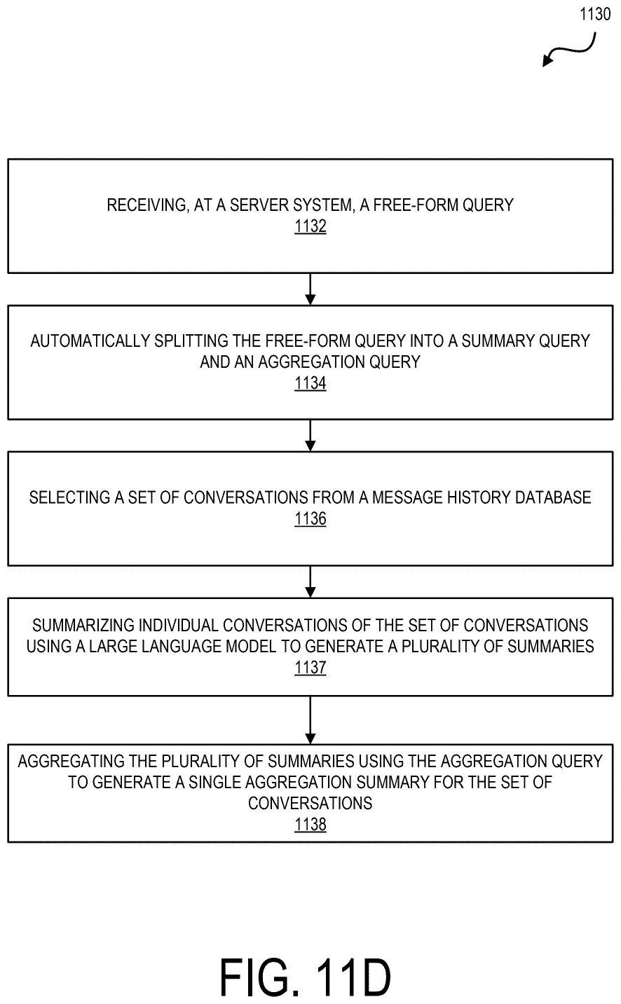

FIG. 11A shows a flowchart of a method 1100 in accordance with some aspects of the present technology. In some aspects, the method 1100 can be implemented in a system by one or more processors configured to perform the operations of the method 1100. The system can be a system implemented using the computing system architecture 1300 described below, or any other such computing system. In some aspects, the method 1100 can be implemented as computer readable instructions in a storage medium.

The method 1100 includes block 1102, which describes receiving, at a server system, a free-form query.

The method 1100 includes block 1104, which describes selecting a number of two-way communication history records from a database associated with the free-form query to identify selected history records.

The method 1100 includes block 1106, which describes generating individual summaries of individual history records of the selected history records. In some aspects, the individual summaries may be generated by processing a set of corresponding individual history records using a chunking algorithm; constructing language responses from outputs of the chunking algorithm using a large language model; aggregating the language responses; and processing the language responses using the large language model to generate an individual summary for corresponding individual history records.

Additional aspects of the method 1100 may operate where the selected history records are selected randomly from the database and/or using a search algorithm.

Additional aspects of the method 1100 may operate where the number of two-way communication history records is less than or equal to 50.

Additional aspects of the method 1100 may include operations further including: selecting a second number of two-way communication history records from a database associated with the free-form query to identify second selected history records; generating second individual summaries of individual history records of the second selected history records by: processing a second set of corresponding individual history records using the chunking algorithm; constructing second language responses from second outputs of the chunking algorithm using the large language model; aggregating the second language responses; and processing the second language responses using the large language model to generate a second individual summary for second corresponding individual history records; and generating, using the large language model, an aggregate summary using the individual summary and the second individual summary.

Additional aspects of the method 1100 may include operations further including: generating a plurality of individual summaries for sets of communication history records numbering less than or equal to a threshold number; processing the plurality of individual summaries using a second large language model different than the large language model to generate an aggregated summary for data of the sets of communication history records.

Additional aspects of the method 1100 may include operations further including: generating a summary query and an aggregation query from the free-form query; generating a plurality of individual summaries for sets of communication history records including the individual summaries using the summary query; and processing the plurality of individual summaries using the aggregation query and a second large language model.

Additional aspects of the method 1100 may include operations further including: determining whether the number of two-way communication history records is greater than a threshold number; and facilitating presentation of the individual summary for the corresponding individual history records as a response to the free-form query when the number of two-way communication history records is not greater than the threshold number.

Additional aspects of the method 1100 may include operations further including: determining whether the number of two-way communication history records is greater than a threshold number, wherein when the number is greater than the threshold number, a response to the free-form query is generated by: dividing the number of two-way communication history records into sets of records including fewer than the threshold number of records; generating, by the large language model, individual summaries for the sets of records; generating, by the large language model, the response as an aggregated summary using the individual summaries.

FIG. 11B shows a flowchart of a method 1110 in accordance with some aspects of the present technology. In some aspects, the method 1110 can be implemented in a system by one or more processors configured to perform the operations of the method 1110. The system can be a system implemented using the computing system architecture 1300 described below, or any other such computing system. In some aspects, the method 1110 can be implemented as computer readable instructions in a storage medium.

The method 1110 includes block 1112, which describes accessing history data for a plurality of two-way communications.

The method 1110 includes block 1114, which describes receiving a natural language query associated with the plurality of two-way communications;

The method 1110 includes block 1116, which describes generating, using a large language model and the natural language query, a summary of the plurality of two-way communications; and

The method 1110 includes block 1118, which describes generating, using the large language model and the natural language query, an aggregated response to the natural language query.

FIG. 11C shows a flowchart of a method 1120 in accordance with some aspects of the present technology. In some aspects, the method 1120 can be implemented in a system by one or more processors configured to perform the operations of the method 1120. The system can be a system implemented using the computing system architecture 1300 described below, or any other such computing system. In some aspects, the method 1120 can be implemented as computer readable instructions in a storage medium.

The method 1120 includes block 1122, which describes receiving, at a server system, a free-form query;

The method 1110 includes block 1124, which describes identifying a plurality of two-way communications associated with the free-form query;

The method 1110 includes block 1126, which describes selecting a threshold number of two-way communication history records from the plurality of two-way communication to identify selected history records;

The method 1110 includes block 1227, which describes processing the selected history records using a large language model to generate individual summaries of individual history records of the selected history records;

The method 1110 includes block 1128, which describes processing the individual summaries to generate an aggregated summary of the selected history records; and

The method 1110 includes block 1129, which describes generating, using the large language model, the individual summaries, and the aggregated summary, an aggregated response to the free-form query.

FIG. 11D shows a flowchart of a method 1130 in accordance with some aspects of the present technology. In some aspects, the method 1130 can be implemented in a system by one or more processors configured to perform the operations of the method 1130. The system can be a system implemented using the computing system architecture 1300 described below, or any other such computing system. In some aspects, the method 1130 can be implemented as computer readable instructions in a storage medium.

The method 1130 includes block 1132, which describes receiving, at a server system, a free-form query;

The method 1130 includes block 1134, which describes splitting the free-form query into a summary query and an aggregation query;

The method 1130 includes block 1136, which describes selecting a set of conversations from a message history database;

The method 1130 includes block 1137, which describes summarizing individual conversations of the set of conversations using a large language model to generate a plurality of summaries; and

The method 1130 includes block 1138, which describes aggregating the plurality of summaries using the aggregation query to generate a single aggregation summary for the set of conversations.

Some aspects of the method 1130 operate where aggregating the plurality of summaries includes: dividing the plurality of summaries into groups of summaries having less than a threshold number of summaries per group; generating summaries for individual groups of the groups of summaries; and generating the single aggregation summary from the summaries for individual groups.

FIG. 12A shows example screen shots of an interface 1200 for insight models in accordance with some aspects of the present technology. FIG. 12A illustrates a system client's ability to choose insights and customize the insight taxonomy. As shown, interface 1200 includes insight list 1210 with insight categories 1211, 1212, 1213, 1214 and insight subcategories 1220. This insight list 1210 can be considered a set of insights available for a certain client of a service that provides communication system insight analysis as described herein. This can, in accordance with examples described herein, be a bank, a medical service provider, a manufacturer or merchant of a product where support is provided for the product, or any other client that supports communications with users as described herein. Interface 1200 can allow a client to add or modify insight categories available to users contacting an AI supported communication system. Subcategory data window 1230 and action tree 1250 allows the client to view and modify data associated with the insight categories available to users. For example, various other illustrated tabs of the user interface 1200, a user may create training data, review annotation quality, train models, and publish a model. FIGS. 12A-D particularly illustrates an example customization interface for establishing insights in accordance with some aspects of the present technology. In the example of FIG. 12A, a taxonomy of insights (e.g. insight list 1210) either be entered manually or selected from a pre-defined list. As a system operates, in some examples AI and machine learning algorithms can create additional insight categories or subcategories. In other examples, the AI or machine learning systems can suggest additional insight categories and a customer can select how these suggestions are added to system operations by selecting suggestions for addition to insight list 1210. In some examples, additional groupings can be present. For example, multiple lists of insight categories can be grouped together according to domain, and each domain may have its own set of insights. The set of insights can be saved by version as generic or customized. Additionally, multiple tiers of subcategories can be used. For example, each of subcategories 1220 can have a sub-subcategory, the sub-subcategories can also have further subcategories structured below them, and so on, depending on the particular structure of actions and refinements to insight determination for a particular system client.

Data window 1230 and action tree 1250 then describe additional information about categories in insight list 1210 and the relationships between the categories in the list. Data window 1230 can be used both to generate training data for an insight category and to display examples of information for actions associated with an insight category or subcategory. ID 1231 is a field that identifies displayed data (e.g. by insight category, subcategory, database entry, etc.), and selection interface 1215 can be used to sort or select data 1238 for display in data window 1230. Data 1238 can include suggested words or phrases that can be associated with an insight category or subcategory. When an insight list 1210 is initially generated, this list can be seeded based on expected information for a client type, and the list of data 1238 can then be updated with words and phrases actually used by users contacting a system. As communications with users occur and the words from a user communication are associated with insight categories, and the communications result in a resolution of the user interaction (e.g. positive and negative resolutions), the words associated with an insight category and successfully resolved can be added to data 1238 for a particular insight. Words that result in unsuccessful resolution, or that frequently result in a system shifting from one insight category and associated actions for the category to a different category with different associated actions can be removed from data 1238 for one category and placed with data for another category. In some examples, annotation information for certain data 1238 can be used to allow a client to make selections to shift phrases and word associations to different insight categories (e.g. using UI selection indicators 1236 to emphasize or de-emphasize associations between certain words and certain insight categories or subcategories.) Different UI tabs 1234 can be used to select different types of data 1238 for display, such as seeded phrases, custom client provided phrases, machine learning suggested phrases, comments or history data for data 1238, or other such information.

Action tree 1250 then allows a visual indication of relationships between different insight categories and subcategories and association actions. The example category indicators shown as category indicator 1252, 1254, and 1256 are shown as associated with action 1258. In some examples, action 1258 can be a request for additional user information to clarify a user's insight and focus a system to a narrower subcategory such as subcategories 1220 from a broader insight category 1212. Action tree 1250 can also be used to visualize relationships between categories that result in the same action 1258 or in different actions that can branch out from an insight category. This action tree 1250 can be used by a client to structure and select actions, and to modify actions associated with certain categories. This can include adding annotation information to be used for certain input words. This can also include an interface to display and modify information about actions or insights that regularly result in negative user feedback or which have poor correlations or results. A client of the system can modify the actions or data for an insight to attempt to achieve better results for the insight category. AI or machine learning systems can, in some examples, make such changes or can suggest changes for client approval based on system history data (e.g. analysis of loops and conversation paths through different words or insight categories that resulted in different resolutions).

Interface 1200 allows a client to insert and track custom insights. Interface 1200 allows these custom insights to be defined and associated with training data. Annotation data can be added to the custom insights to set a bar on the insight detection quality for the model(s) associated with custom insights in a system. In some examples, this can allow modifications to a system to be modeled in an analysis system before updates or changes to the interface category structures are published to an active system that is accessible by users. This can include creation of an offline system (e.g. an updated version of insight management engine 615) that can be processed with training data, annotation quality, and trained models prior to publication to users. Additionally, such an offline system can be used to update a published system by making changes using updated training data generated using active system histories. This can include integrating customer feedback and system results into the training data used for updated versions of a prior published system, and integration of new annotation quality data into new versions of a system as more information is gathered, or as features and changes to system structures occur. For example, if a client of a system releases a new product with different associated actions than previous products, and old products are no longer supported, the actions for a client can change, and the expected user words and associations between words in user communications can change. Such changes can be modeled with an offline version prior to publication to a live user facing system. Similarly, as a banking system rolls out new products, as a medical service offers new procedures, or as other clients business changes result in changes to expected communications from clients, the communication system can be updated to accommodate these changes and to keep track of changes in insight categories for users that contact the system for information and actions associated with a client.

FIGS. 12B-C show examples of aspects of dashboard reports for an insight-driven contact center in accordance with some aspects of the present technology. Some aspects can include a dashboard filter interface showing metrics for communications and insights. For example, a dashboard filter can include data that illustrates summary information about a number of conversations, an average duration of a communication session, an insight score, insights by conversations, insight trends, insight durations, or other such information as data using data summary interface, data metric graphics, and chart 1216 data. These analytics can become available as users contact the insight-driven contact center and their insights are ascertained. Interface elements for adding filters, selecting filters, and setting value ranges for filters can be used to select the displayed data using add filter element, filter type selections, filter value selections and other such user interface selections. For example, in the illustrated filter interface, data summary interfaces can show different summary data types in associated data areas of each interface area, along with an associated trend arrow for each interface. Chart can show a volume of insight category assignments over time. For example, each line of charts 1216 can indicate a volume of insight assignments in a given hour of a day for a given geographic area (e.g. where insight assignments drop to near zero in the middle of the night). Each insight category can have a one or more associated data summary interface that shows statistical values about the insight category, such as a daily average volume, a weekly average volume, a weekly average trend (e.g. change) over the past year, or any other such metrics. Examples described herein can facilitate display of insight and metric data for an AI assistance communication system using an interface such as filter interface 1200 or other such interfaces.

FIGS. 12B-C includes aspects of a interfaces showing top insights scores and the associated view settings 1220 interface with calibration settings available to manage top insights scores displayed in interface areas. The example view settings 1220 interface allows data categorization selections 1224 to assign a qualitative text value to insight scores (e.g. excellent, great, good, fair, poor). Additionally, interface elements such as view type selection 1222 can be used to select standard settings for a particular data summary interface.

FIGS. 12C, 12B are examples of chart 1216 data, shown as charts 1216B, and 1216C. Each example chart 1216 is a dashboard report showing volumes of conversations by insight, with a horizontal time axis 1217, and a vertical volume axis 1218. The particular insight data for a chart 1216 can be selected using a chart selection interface 1215 value. This can select one or more filter characteristics for the insight data of a chart (e.g. overall time period, geographic area, associated agent(s), insight subgroups for an insight category, related insight category groupings, etc.) Illustrated chart 1216B includes tracking data 1232, and chart 1216C includes tracking data 1232. The volume axis 1218 shows a number of times an insight category is assigned in a time period along time axis 1217. The time axis can be structure so that each data point is the number of assignments per minute, per ten-minute increment, per hour, or per any other selected period for time axis 1217. In some implementations, the time axis 1217 period can be set by a user interface selection of an interface such as filter interface 1200.

Some aspects can include a dashboard showing aspects of agent conversations with users. As described herein, in some examples, actions taken by a system can be fully automated, so that an insight category results in an automated action taken by a system (e.g. a responsive communication transmitted using system AI, language processing, or other systems). In other examples, some or all actions can be AI assisted actions involving an agent using a computing device to implement the AI assistance to the agent. In such implementations, system data can be tracked by insight categorization and by agent. Such a dashboard can include an agent list that allows a particular agent to be selected. Agent trend data and associated summary data can show metrics that integrate insight data and agent data in one or more summary areas of an interface. This can include trends in how long a conversation with a given insight category lasts for a given agent, and statistical trends overtime for the agent. This can include trends for different insight categories or groups of insight categories or subcategories. Examples of specific conversations involving an agent and a user can be displayed in agent history data. In some examples, AI systems can process all communications involving an agent and generate a representative set of conversations, including an average conversation and any conversations that fall outside of sets of threshold parameters. Additionally, the natural language processing systems or other systems used to identify words from user communications can also be used to identify certain words in agent responsive communications in text data for an agent conversation. Such information can be displayed in agent history data interface, along with additional agent summary data and agent review data. The dashboard of agent history data, agent summary, and agent review data shows messages exchanged with the user, overall metrics for agent conversations, and ratings and resolutions boxes. Agent summary data can include metrics on agent performance such as user ratings, conversation times, comparative rankings with other agents, areas or insight categories where the agent's conversations are above or below threshold comparisons with other agents, or other such information. Agent review data can include specific feedback received by a system from users that are part of conversations with a given agent. As described above, such agent information can be used to assess system updates as feedback and trends are integrated into the AI and machine learning systems. For example, in some implementations, only insight data associated with agents having certain summary data metrics (e.g. threshold response times, threshold user feedback scores, etc.) are used in updating AI systems using machine learning.

Some aspects can include an agent ranking interface for an insight-driven contact center in accordance with some aspects of the present technology. The agent rankings include agents by total customers engaged and agents by volume of conversation. These analytics can become available as conversations are handled and resolved by agents over time, and can include a list of top ranked agents for a given insight category, along with a graphic with an agent comparison. The agent comparison graphic can include a top metric value for a top agent, and color bars showing a share of volume handled by the top agents. Similarly, agent data can include a list of lowest performing agents with a similar graphic for agent comparison, that can show a lowest performance value for a lowest ranked agent. Such an agent ranking interface can provide system feedback on performance variation. In some systems, information about the standard deviation among agents and various bands of performance can be presented. As with other interfaces, this information can be broken down by insight category, time, geography, or any category of data stored by a system.

In various implementations, the above AI and machine learning systems can be integrated with interfaces to provide information about system use and operation. Such interfaces can be dynamically and continuously updated in real-time (e.g. as processed given resource limits) to provide feedback on system performance and system use. Such examples improve the operations of a communication system by providing information on the performance of the system and allowing errors or improvements in the system to be identified prior to failures. Such interfaces additional improve the operations of a communication system by facilitating updates for added functionality and actions in response to user insights (e.g. addition of new actions as new communication paths or functionality is added to respond to user preferences and to meet user insight associated with the user accessing a communication system). Further, the AI and machine learning systems above provide improvements to the performance of the devices beyond the interfaces. As described above, this includes improvements in responsive performance and reduction of processing resources that are wasted when actions taken by a system that use computing resources do not align with results expected by a user. These resources are wasted, and additional resources are used in system loops as the system attempts to arrive at an action that meets a user insight. The described improvements in insight matching of user communications to insight categories improves the efficiency of the involved computing devices, saving power and system resources while providing communication and processing utility to users on behalf of system clients (e.g. that structure the insight categories and actions for users). While various steps are described above, it will be apparent that certain steps can be repeated, and intervening steps can be performed as well. Additionally, different devices in a system will perform corresponding steps, and various devices can be performing multiple steps simultaneously. For example, a device can perform such steps to route requests to multiple agents simultaneously, with devices of multiple different agents performing corresponding operations, and the agent devices communicating with user devices.

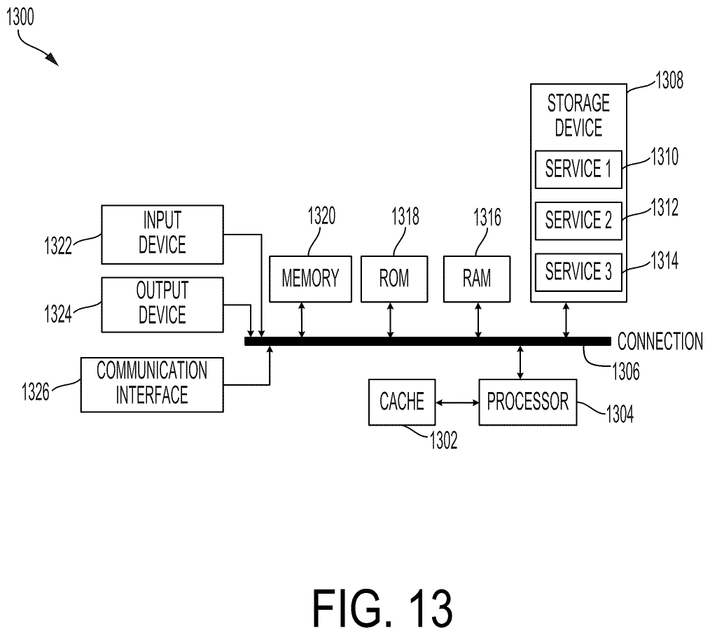

FIG. 13 illustrates a computing system architecture 1300 including various components in electrical communication with each other using a connection 1306, such as a bus, in accordance with some implementations. Example system architecture 1300 includes a processing unit (CPU or processor) 1304 and a system connection 1306 that couples various system components including the system memory 1320, such as ROM 1318 and RAM 1316, to the processor 1304. The system architecture 1300 can include a cache 1302 of high-speed memory connected directly with, in close proximity to, or integrated as part of the processor 1304. The system architecture 1300 can copy data from the memory 1320 and/or the storage device 1308 to the cache 1302 for quick access by the processor 1304. In this way, the cache can provide a performance boost that avoids processor 1304 delays while waiting for data. These and other modules can control or be configured to control the processor 1304 to perform various actions.

Other system memory 1320 may be available for use as well. The memory 1320 can include multiple different types of memory with different performance characteristics. The processor 1304 can include any general purpose processor and a hardware or software service, such as service 1 1310, service 2 1312, and service 3 1314 stored in storage device 1308, configured to control the processor 1304 as well as a special-purpose processor where software instructions are incorporated into the actual processor design. The processor 1304 may be a completely self-contained computing system, containing multiple cores or processors, a bus, memory controller, cache, etc. A multi-core processor may be symmetric or asymmetric.

To enable user communication with the computing system architecture 1300, an input device 1322 can represent any number of input mechanisms, such as a microphone for speech, a touch-sensitive screen for gesture or graphical input, keyboard, mouse, motion input, speech and so forth. An output device 1324 can also be one or more of a number of output mechanisms known to those of skill in the art. In some instances, multimodal systems can enable a user to provide multiple types of input to communicate with the computing system architecture 1300. The communications interface 1326 can generally govern and control the user input and system output. There is no restriction on operating on any particular hardware arrangement and therefore the basic features here may easily be substituted for improved hardware or firmware arrangements as they are developed.

Storage device 1308 is a non-volatile memory and can be a hard disk or other types of computer readable media which can store data that are accessible by a computer, such as magnetic cassettes, flash memory cards, solid state memory devices, digital versatile disks, cartridges, RAMs 1316, ROM 1318, and hybrids thereof.

The storage device 1308 can include services 1310, 1312, 1314 for controlling the processor 1304. Other hardware or software modules are contemplated. The storage device 1308 can be connected to the system connection 1306. In one aspect, a hardware module that performs a particular function can include the software component stored in a computer-readable medium in connection with the necessary hardware components, such as the processor 1304, connection 1306, output device 1324, and so forth, to carry out the function.

The disclosed gift selection, attribution, and distribution system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form. As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform as events occur or in batch mode aggregating multiple events, such as over one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couples the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file routing system, such as a disk operating system. One example of operating system software with associated file routing system software is the family of operating systems known as Windows® from Microsoft Corporation of Redmond, WA, and their associated file routing systems. Another example of operating system software with its associated file routing system software is the Linux™ operating system and its associated file routing system. The file routing system can be stored in the non-volatile memory and/or drive unit and can cause the processor to execute the various acts involved by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless ally stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The involved structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

In general, the routines executed to implement the implementations of the disclosure, may be implemented as part of an operating system or an application, component, program, object, module or sequence of instructions referred to as “computer programs.” The computer programs typically include one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may include a transformation, such as a physical transformation. With particular types of memory devices, such a physical transformation may include a physical transformation of an article to a different state or thing. For example, but without limitation, for some types of memory devices, a change in state may involve an accumulation and storage of charge or a release of stored charge. Likewise, in other memory devices, a change of state may include a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may include a transformation, such as a physical transformation. Rather, the foregoing is intended as illustrative examples.

A storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any characteristics, features, or aspects of the disclosure with which that terminology is associated. In general, the terms used in the following claims should not be construed to limit the disclosure to the implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 132(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without insight to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object including a computer-readable medium containing computer program code, which can be executed by a computer processor for performing any or all of the steps, operations, or processes described.

Examples may also relate to an apparatus for performing the operations herein. This apparatus may be specially constructed for the involved purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may include information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

details were given in the preceding description to provide a thorough understanding of various implementations of systems and components for a contextual connection system. It will be understood by one of ordinary skill in the art, however, that the implementations described above may be practiced without these details. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a keypad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

The program code may be executed by a processor, which may include one or more processors, such as one or more digital signal processors (DSPs), general purpose microprocessors, an application integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The foregoing detailed description of the technology has been presented for purposes of illustration and description. It is not intended to be exhaustive or to limit the technology to the precise form disclosed. Many modifications and variations are possible in light of the above teaching. The described examples were chosen in order to best explain the principles of the technology, its practical application, and to enable others skilled in the art to utilize the technology in various examples and with various modifications as are suited to the particular use contemplated. It is intended that the scope of the technology be defined by the claim.

What is claimed is:

1. A computer-implemented method comprising:
receiving, at a server system, a free-form query;
selecting two-way communication history records from a database associated with the free-form query to identify selected history records; and
generating individual summaries of individual history records of the selected history records by:
processing a set of corresponding individual history records using a chunking algorithm;
constructing language responses from outputs of the chunking algorithm using a large language model;
aggregating the language responses; and
processing the language responses using the large language model to generate an individual summary for corresponding individual history records.

2. The computer-implemented method of claim 1, wherein the selected history records are selected from the database either randomly or using a search algorithm.

3. The computer-implemented method of claim 1, wherein a number of two-way communication history records is less than or equal to 50.

4. The computer-implemented method of claim 1, further comprising:
selecting a second number of two-way communication history records from a database associated with the free-form query to identify second selected history records;
generating second individual summaries of individual history records of the second selected history records by:
processing a second set of corresponding individual history records using the chunking algorithm;
constructing second language responses from second outputs of the chunking algorithm using the large language model;
aggregating the second language responses; and
processing the second language responses using the large language model to generate a second individual summary for second corresponding individual history records; and
generating, using the large language model, an aggregate summary using the individual summary and the second individual summary.

5. The computer-implemented method of claim 1, further comprising:
generating a plurality of individual summaries for sets of communication history records numbering less than or equal to a threshold number;
processing the plurality of individual summaries using a second large language model different than the large language model to generate an aggregated summary for data of the sets of communication history records.

6. The computer-implemented method of claim 1, further comprising:
generating a summary query and an aggregation query from the free-form query; generating a plurality of individual summaries for sets of communication history records including the individual summaries using the summary query; and
processing the plurality of individual summaries using the aggregation query and a second large language model.

7. The computer-implemented method of claim 1, further comprising:
determining whether a number of two-way communication history records is greater than a threshold number; and
facilitating presentation of the individual summary for the corresponding individual history records as a response to the free-form query when the number of two-way communication history records is not greater than the threshold number.

8. The computer-implemented method of claim 1, further comprising:
determining whether a number of two-way communication history records is greater than a threshold number, wherein when the number is greater than the threshold number, a response to the free-form query is generated by:
dividing the number of two-way communication history records into sets of records including fewer than the threshold number of records;
generating, by the large language model, individual summaries for the sets of records; and
generating, by the large language model, the response as an aggregated summary using the individual summaries.

9. A system comprising:
a memory; and
one or more processors coupled to the memory and configured to perform operations comprising:
receiving, at a server system, a free-form query;
selecting two-way communication history records from a database associated with the free-form query to identify selected history records; and
generating individual summaries of individual history records of the selected history records by:
processing a set of corresponding individual history records using a chunking algorithm;
constructing language responses from outputs of the chunking algorithm using a large language model;
aggregating the language responses; and
processing the language responses using the large language model to generate an individual summary for corresponding individual history records.

10. The system of claim 9, wherein the selected history records are selected from the database either randomly or using a search algorithm.

11. The system of claim 9, wherein a number of two-way communication history records is less than or equal to 50.

12. The system of claim 9, wherein the one or more processors are further configured to perform operations comprising:
selecting a second number of two-way communication history records from a database associated with the free-form query to identify second selected history records;
generating second individual summaries of individual history records of the second selected history records by:
processing a second set of corresponding individual history records using the chunking algorithm;
constructing second language responses from second outputs of the chunking algorithm using the large language model;
aggregating the second language responses; and
processing the second language responses using the large language model to generate a second individual summary for second corresponding individual history records; and
generating, using the large language model, an aggregate summary using the individual summary and the second individual summary.

13. The system of claim 9, wherein the one or more processors are further configured to perform operations comprising:
generating a plurality of individual summaries for sets of communication history records numbering less than or equal to a threshold number;
processing the plurality of individual summaries using a second large language model different than the large language model to generate an aggregated summary for data of the sets of communication history records.

14. The system of claim 9, wherein the one or more processors are further configured to perform operations comprising:
generating a plurality of individual summaries for sets of communication history records numbering less than or equal to a threshold number;
processing the plurality of individual summaries using a second large language model different than the large language model to generate an aggregated summary for data of the sets of communication history records.

15. The system of claim 9, wherein the one or more processors are further configured to perform operations comprising:
generating a summary query and an aggregation query from the free-form query; generating a plurality of individual summaries for sets of communication history records including the individual summaries using the summary query; and
processing the plurality of individual summaries using the aggregation query and a second large language model.

16. A non-transitory computer-readable storage medium comprising instructions that, when executed by one or more processors of a computing system, cause the computing system to perform operations comprising:
receiving, at a server system, a free-form query;
selecting two-way communication history records from a database associated with the free-form query to identify selected history records; and
generating individual summaries of individual history records of the selected history records by:
processing a set of corresponding individual history records using a chunking algorithm;
constructing language responses from outputs of the chunking algorithm using a large language model;
aggregating the language responses; and
processing the language responses using the large language model to generate an individual summary for corresponding individual history records.

17. The non-transitory computer-readable storage medium of claim 16, wherein the selected history records are selected from the database either randomly or using a search algorithm.

18. The non-transitory computer-readable storage medium of claim 16, wherein a number of two-way communication history records is less than or equal to 50.

19. The non-transitory computer-readable storage medium of claim 16, wherein when executed by one or more processors of a computing system, the instructions cause the computing system to perform operations comprising:
generating a plurality of individual summaries for sets of communication history records numbering less than or equal to a threshold number;
processing the plurality of individual summaries using a second large language model different than the large language model to generate an aggregated summary for data of the sets of communication history records.

20. The non-transitory computer-readable storage medium of claim 16, wherein when executed by one or more processors of a computing system, the instructions cause the computing system to perform operations comprising:
generating a summary query and an aggregation query from the free-form query; generating a plurality of individual summaries for sets of communication history records including the individual summaries using the summary query; and
processing the plurality of individual summaries using the aggregation query and a second large language model.
